(19) United States
(12) Patent Application Publication
(10) Pub. No.: US 2022/0411445 A1
(43) Pub. Date: Dec. 29, 2022

(54) SULFUR-CONTAINING INORGANIC-ORGANIC HYBRID MATERIALS AND METHODS FOR MAKING THE SAME

(71) Applicant: The University of Chicago, Chicago, IL (US)

(72) Inventors: John S. Anderson, Chicago, IL (US); Jiaze Xie, Chicago, IL (US); Noah E. Horwitz, Chicago, IL (US); Airi Kawamura, Santa Cruz, CA (US)

(21) Appl. No.: 17/771,266

(22) PCT Filed: Oct. 22, 2020
(86) PCT No.: PCT/US20/56808

§ 371 Date: Apr. 22, 2022

Related U.S. Application Data
(60) Provisional application No. 62/925,310, filed on Oct. 24, 2019.

(51) Int. Cl. C07F 7/22; C07F 7/08; C07F 15/04

(52) U.S. Cl. CPC C07F 7/226; C07F 7/0814; C07F 15/04

(57) ABSTRACT

Coordination complexes of tetrathiafulvalene-based dithiolene linkers, such as tetrathiafulvalene-2,3,6,7-tetrathiolate (TTFtt), and their oxidation products are described. The coordination complexes can include metals such as tin or silicon. Also described are methods of using the coordination complexes in transmetallation reactions, e.g., to prepare sulfur coordination polymers, and sulfur coordination polymers doped with tetrathiafulvalene-based dithiolene linkers having different oxidation states.

### RELATED APPLICATIONS

The presently disclosed subject matter claims the benefit of U.S. Provisional Patent Application Ser. No. 62/925,310, filed Oct. 24, 2019, the disclosure of which is incorporated herein by reference in its entirety.

### STATEMENT OF GOVERNMENT SUPPORT

This invention was made with government support under grant number DESC0019215 awarded by the U.S. Department of Energy. The government has certain rights in the invention.

### TECHNICAL FIELD

The presently disclosed subject matter relates to coordination complexes (e.g., tin or silicon coordination complexes) of tetrathiafulvalene-2,3,6,7-tetrathiolate (TTFtt) and their use in transmetallation reactions, for example, to prepare sulfur-containing inorganic-organic hybrid materials, such as sulfur coordination polymers. The presently disclosed subject matter further relates to coordination polymers comprising TTFtt ligands and to methods of doping coordination polymers with TTFtt ligands having different oxidation states.

### ABBREVIATIONS

° C.=degrees Celsius
%=percent
μA=microampere
μM=micromolar
Å=angstrom
AcO=acetyl
BAr^{F}₄=tetrakis(3,5-bis(trifluoromethyl)-phenyl) borate
Bu=butyl
BzO=benzoyl
cm=centimeter
CV=cyclic voltammetry
DCM=dichloromethane
DMF=dimethyl formamide
dppe=ethylenebis(diphenylphosphine)
EPR=electron paramagnetic resonance
EXAFS=extended X-ray absorption fine structure
Fc⁺=ferrocenium
g=gram
Ge=germanium
mA=milliampere
MeCN=acetonitrile
MeOH=methanol
min=minutes
mL=milliliter
mmol=millimoles
Ni=nickel
NIR=near infrared
nm=nanometers
NO=natural orbitals
NON=natural occupation numbers
PG=protecting group
Ph=phenyl
S=sulfur
Si=silicon
S/cm=Siemens per centimeter
Sn=tin
SXRD=single crystal x-ray diffraction
THF=tetrahydrofuran
TTF=tetrathiafulvalene
TTFtt=tetrathiafulvalene-2,3,6,7-tetrathiolate
UV=ultraviolet
V=volt
V2RDM=variational 2-electron reduced density matrix
vis=visible
XRD=x-ray diffraction

### BACKGROUND

Conjugated coordination polymers have attracted recent attention due to promising applications in superconductors,¹ energy storage,² thermoelectrics,³ spintronics,⁴ and other fields.^{5,6,7} However, delocalized metal-organic systems are still rare, and most coordination polymers are limited to architectures constructed with nitrogen- and oxygen-based ligands.^{7,8}

Yet, some of the most conductive materials⁹ in this area have instead used sulfur-based linkers, which are perhaps best exemplified by dithiolene units that leverage both a better energy match¹⁰ between sulfur atoms and metal centers and ligand-based redox activity.^{4a} Nevertheless, stability and controllable synthetic conditions are still significant challenges associated with the incorporation of dithiolene-based linkers.

Accordingly, there is an ongoing need for additional methods and reagents for preparing coordination polymers comprising sulfur-based linkers. In particular, there is an ongoing need for additional methods and reagents related to tetrathiafulvalene-based dithiolene linkers, such as tetrathiafulvalene-2,3,6,7-tetrathiolate.

### SUMMARY

In some embodiments, the presently disclosed subject matter provides a coordination complex having a structure of Formula (I):

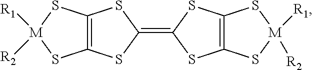

wherein: M is selected from Si, Ge, and Sn; and R₁ and R₂ are independently selected from alkyl, aralkyl, and aryl. In some embodiments, M is Sn. In some embodiments, M is Si.

In some embodiments, R₁ and R₂ are each C₁-C₆ alkyl. In some embodiments, R₁ and R₂ are each butyl. In some embodiments, R₁ and R₂ are each phenyl.

In some embodiments, the presently disclosed subject matter provides a complex comprising (a) an oxidation product of the coordination complex of Formula (I), wherein said oxidation product comprises a cation radical or a dication, and (b) an anionic species.

In some embodiments, the presently disclosed subject matter provides a method of preparing a coordination polymer, wherein the method comprises: (a) providing a first coordination complex having a structure of Formula (I):

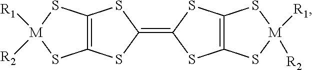

wherein: M is a first metal selected from Si, Ge, and Sn; and R₁ and R₂ are independently selected from alkyl, aralkyl, and aryl; and (b) contacting the first coordination complex from (a) with a second coordination complex comprising a second metal M′, wherein M′ is a transition metal, thereby forming a coordination polymer comprising repeating coordination complexes comprising M′ and tetrathiolate ligands.

In some embodiments, M′ is selected from Fe, Cr, Mo, Ni, W, Co, Cu, and Mn. In some embodiments, the second coordination complex comprises a metal cluster comprising the second metal M′. In some embodiments, the metal cluster is a metal sulfur cluster.

In some embodiments, the method further comprises contacting the first coordination complex with an oxidant prior to or during step (b). In some embodiments, the method provides a coordination polymer with improved conductivity compared to a coordination polymer formed by contacting the first coordination complex with the second coordination complex without contacting the first coordination complex with one or more oxidant prior to or during the contacting with the second coordination complex. In some embodiments, the conductivity is improved by about 1000 times.

In some embodiments, the first coordination complex is contacted with at least one equivalent of the oxidant. In some embodiments, the oxidant is a ferrocenium compound. In some embodiments, the ferrocenium compound is an acetyl ferrocenium. In some embodiments, the ferrocenium compound is a benzoyl ferrocenium compound. In some embodiments, the ferrocenium compound is a salt of a borate anion. In some embodiments, the borate anion is tetrakis(3,5-bis(trifluoromethyl)phenyl) borate.

In some embodiments, the method further comprises adding a modulating agent during step (b). In some embodiments, the modulating agent is thiophenol.

In some embodiments, the presently disclosed subject matter provides a coordination polymer prepared by a method comprising: (a) providing a first coordination complex having a structure of Formula (I):

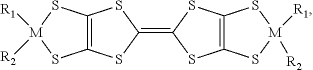

wherein: M is a first metal selected from Si, Ge, and Sn; and R₁ and R₂ are independently selected from alkyl, aralkyl, and aryl; and (b) contacting the first coordination complex from (a) with a second coordination complex comprising a second metal M′, wherein M′ is a transition metal, thereby forming a coordination polymer comprising repeating coordination complexes comprising M′ and tetrathiolate ligands.

In some embodiments, the presently disclosed subject matter provides a method of preparing a coordination polymer, wherein the method comprises: (a) providing a mixture comprising at least two first coordination complexes, wherein each of said two first coordination complexes is selected from the group comprising: (i) a coordination complex having a structure of Formula (I):

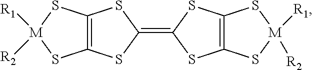

wherein: M is a first metal selected from Si, Ge, and Sn; and R₁ and R₂ are independently selected from alkyl, aralkyl, and aryl; (ii) a cation radical thereof; and (iii) a dication thereof; and (b) contacting the mixture from (a) with a second coordination complex comprising a second metal M′, wherein M′ is a transition metal, thereby forming a coordination polymer comprising repeating coordination complexes comprising M′ and tetrathiolate ligands.

In some embodiments, M′ is selected from Fe, Cr, Mo, Ni, W, Co, Cu, and Mn. In some embodiments, the second coordination complex comprises a metal cluster comprising the second metal M′. In some embodiments, the metal cluster is a metal sulfur cluster.

In some embodiments, the method provides a coordination polymer with improved conductivity compared to a coordination polymer formed by contacting the second metal complex with a first coordination complex having a structure of Formula (I) without a second first coordination complex. In some embodiments, the ratio of first coordination complexes is selected to provide a coordination complex with a particular level of cation radical and/or dication doping.

In some embodiments, the method further comprises adding a modulating agent during step (b). In some embodiments, the modulating agent is thiophenol.

In some embodiments, the presently disclosed subject matter provides a coordination polymer prepared from a method comprising: (a) providing a mixture comprising at least two first coordination complexes, wherein each of said two first coordination complexes is selected from the group comprising: (i) a coordination complex having a structure of Formula (I):

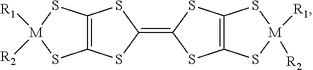

wherein: M is a first metal selected from Si, Ge, and Sn; and R₁ and R₂ are independently selected from alkyl, aralkyl, and aryl; (ii) a cation radical thereof; and (iii) a dication thereof; and (b) contacting the mixture from (a) with a second coordination complex comprising a second metal M′, wherein M′ is a transition metal, thereby forming a coordination polymer comprising repeating coordination complexes comprising M′ and tetrathiolate ligands.

In some embodiments, the presently disclosed subject matter provides a coordination polymer comprising repeating coordination complexes comprising (i) a transition metal or a transition metal cluster and (ii) tetrathiolate ligands, wherein the tetrathiolate ligands comprise tetrathiafulvalene-2,3,6,7-tetrathiolate (TTFtt) and/or an oxidation product thereof, wherein said repeating coordination complexes extend in one, two or three dimensions. In some embodiments, the transition metal is selected from Fe, Cr, Mo, Ni, W, Co, Cu and Mn.

In some embodiments, the transition metal is part of a transition metal cluster. In some embodiments, the transition metal cluster is a metal sulfur cluster.

In some embodiments, the coordination polymer has a conductivity that is greater than about 0.0001 S/cm.

In some embodiments, the presently disclosed subject matter provides a method of doping a coordination polymer, the method comprising: (a) providing a mixture of at least two different types of ligands selected from the group comprising tetrathiafulvalene-2,3,6,7-tetrathiolate (TTFtt), a cation radical thereof, and a dication thereof; and (b) contacting the mixture of ligands with a transition metal M′. In some embodiments, the mixture of ligands comprises a predetermined ratio of the at least two different types of ligands, wherein the ratio is predetermined to achieve a desired doping level of oxidation states in the coordination polymer.

In some embodiments, at least one of the at least two different types of ligands is provided as a tin, silicon, or germanium coordination complex. In some embodiments, the transition metal M′ is part of a coordination complex or a metal cluster.

In some embodiments, the presently disclosed subject matter provides a composition comprising a mixture of at least two types of tetrathiafulvalene-2,3,6,7-tetrathiolate (TTFtt) ligands, wherein each type of ligand has a different oxidation state. In some embodiments, the mixture comprises at least two of: (i) a coordination complex having a structure of Formula (I):

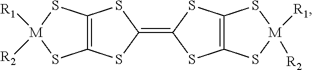

wherein: M is a first metal selected from Si, Ge, and Sn; and R₁ and R₂ are independently selected from alkyl, aralkyl, and aryl; (ii) a cation radical thereof; and (iii) a dication thereof.

Accordingly, it is an object of the presently disclosed subject matter to provide coordination complexes of Formula (I) and related oxidation products, methods of preparing coordination polymers using the coordination complexes, methods of doping coordination polymers, mixtures of TTFtt ligands having different oxidation states, and coordination polymers comprising TTFtt ligands.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIG. 1A is schematic diagram showing an exemplary route to the synthesis of the bis-dibutylstanylated complex of tetrathiafulvalene-2,3,6,7-tetrathiolate (TTFtt), also referred to herein as compound or complex 1.

FIG. 1B is a schematic diagram showing exemplary routes to the synthesis of tin (Sn) and nickel (Ni) complexes with tetrathiafulvalene-2,3,6,7-tetrathiolate (TTFtt) as a bridging ligand.

FIG. 2A is a graph showing the cyclic voltammogram of the bis-dibutylstanylated complex of tetrathiafulvalene-2,3,6,7-tetrathiolate (TTFtt), also referred to herein as compound or complex 1.

FIG. 2B is a graph showing the cyclic voltammogram of a nickel complex of the cation radical of tetrathiafulvalene-2,3,6,7-tetrathiolate (TTFtt), also referred to herein as compound or complex 5.

FIG. 3 is a schematic diagram showing the single crystal X-ray diffraction (SXRD) structures of the complexes described in FIG. 1B or acetonitrile (MeCN) or tetrahydrofuran (THF) solvates thereof. The structures correspond to: (top left) 1.2MeCN; (middle left) 2.0.5THF.0.5MeCN; (bottom left) 3.4THF; (top right) 5; and (bottom right) 6. [BAr^{F4}] anions, solvent, H atoms, and disorder are omitted, and n-butyl and phenyl groups are shown in wireframe for clarity. The labeling scheme shown for 1 applies for all compounds. Ellipsoids are shown at 50% probability.

FIG. 4A is a graph showing the ultraviolet-visible-near infrared (Uv-vis-NIR) spectra of the bis-dibutylstanylated complex of tetrathiafulvalene-2,3,6,7-tetrathiolate (TTFtt) (also referred to herein as compound or complex 1, solid line); of the bis-dibutylstanylated complex of the cation radical of TTFtt (also referred to herein as compound or complex 2, dotted line); and of the bis-dibutylstanylated complex of the dication of TTFtt (also referred to herein as compound or complex 3, dotted and dashed line) in dichloromethane (DCM). The concentration of 1 is 92 micromolar (μM) and the concentrations of 2 and 3 are each 50 μM.

FIG. 4B is a graph showing the ultraviolet-visible-near infrared (Uv-vis-NIR) spectra of a nickel (Ni) complex of the cation radical of tetrathiafulvalene-2,3,6,7-tetrathiolate (TTFtt) (also referred to herein as compound or complex 5, solid line) and of the Ni complex of the dication of TTFtt (also referred to herein as compound or complex 6, dotted line) in dichloromethane (DCM). The concentration of both complexes is 50 micromolar (μM).

FIG. 5A is a graph showing the electron paramagnetic resonance (EPR) spectrum of the bis-dibutylstanylated complex of the cation radical of tetrathiafulvalene-2,3,6,7-tetrathiolate (TTFtt), also referred to herein as compound or complex 2, in tetrahydrofuran (THF) at 15 Kelvin (K).

FIG. 5B is a graph showing the electron paramagnetic resonance (EPR) spectrum of a nickel (Ni) complex of the cation radical of tetrathiafulvalene-2,3,6,7-tetrathiolate (TTFtt), also referred to herein as compound or complex 5, in tetrahydrofuran (THF) at 15 Kelvin (K).

FIG. 6 is a schematic diagram showing a stacking diagram for a twisted polymorph of a nickel (Ni) complex of the cation radical of tetrathiafulvalene-2,3,6,7-tetrathiolate (TTFtt), i.e., the compound or complex 5, with Ph groups, hydrogen atoms, and anions removed for clarity. The computationally examined parallel dimer, orthogonal dimer, and orthogonal trimer are indicated.

FIG. 7 is a schematic diagram showing an exemplary synthesis of a sulfur coordination polymer from molybdenum (Mo) sulfur clusters and a bis-dibutylstanylated complex of tetrathiafulvalene-2,3,6,7-tetrathiolate (TTFtt).

FIG. 8A is a schematic diagram showing the structure of an exemplary sulfur coordination polymer comprising repeating coordination complexes of a metal ion or cluster M and redox active tetrathiafulvalene-2,3,6,7-tetrathiolate (TTFtt) ligands.

FIG. 8B is a series of graphs showing the x-ray powder diffraction (XRPD) spectra of coordination polymers prepared according to the scheme described in FIG. 7, using different amounts of an exemplary modulating agent, thiophenol. The amount of thiophenol used in the preparation varies from top to bottom as: 0 equivalents; 50 equivalents, 100 equivalents, 200 equivalents, and 400 equivalents. By adding the modulating agent, some phase grows, indicating crystallinity improvement.

FIG. 9 is a schematic drawing showing an exemplary route to the synthesis of a bis-diphenylsilicon complex of tetrathiafulvalene-2,3,6,7-tetrathiolate (TTFtt).

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

Throughout the specification and claims, a given chemical formula or name shall encompass all optical and stereoisomers, as well as racemic mixtures where such isomers and mixtures exist.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of size, temperature, time, weight, volume, concentration, capacitance, specific capacity, discharge capacity, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes, but is not limited to, 1, 1.5, 2, 2.75, 3, 3.90, 4, and 5).

As used herein the term “alkyl” can refer to C₁₋₂₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The aromatic ring(s) can comprise phenyl, naphthyl, and biphenyl, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon aromatic rings.

The term “aralkyl” refers to an -alkyl-aryl group. An exemplary aralkyl group is benzyl (i.e., —CH₂—C₆H₅).

A “coordination complex” is a compound in which there is a coordinate bond between a metal ion and an electron pair donor, which can also be referred to herein as a “ligand” or “chelating group”. Thus, ligands or chelating groups are generally molecules or molecular ions having unshared electron pairs available for donation to a metal ion.

The term “coordinate bond” refers to an interaction between an electron pair donor and a coordination site on a metal ion resulting in an attractive force between the electron pair donor and the metal ion. The use of this term is not intended to be limiting, in so much as certain coordinate bonds also can be classified as having more or less covalent character (if not entirely covalent character) depending on the characteristics of the metal ion and the electron pair donor.

As used herein, the term “ligand” refers generally to a species, such as a molecule or ion, which interacts, e.g., binds, in some way with another species. More particularly, as used herein, a “ligand” can refer to a molecule or ion that binds a metal ion in solution to form a “coordination complex.” See Martell, A. E., and Hancock, R. D., Metal Complexes in Aqueous Solutions, Plenum: New York (1996), which is incorporated herein by reference in its entirety. The terms “ligand” and “chelating group” can be used interchangeably. The term “bridging ligand” can refer to a group that bonds to more than one metal ion or complex, thus providing a “bridge” between the metal ions or complexes. Organic bridging ligands can have two or more groups with unshared electron pairs separated by, for example, an alkylene or arylene group (i.e., a bivalent alkyl or aryl group). Groups with unshared electron pairs, include, but are not limited to, —CO₂H, —NO₂, amino, hydroxyl, thio, thioalkyl, —B(OH)₂, —SO₃H, PO₃H, phosphonate, and heteroatoms (e.g., nitrogen, oxygen, or sulfur) in heterocycles. In some embodiments, the term “ligand” as described herein can refer to a group having two or more thio groups.

The terms “thiol” and “thio” as used herein refer to —SH or S⁻ groups.

The term “coordination site” when used herein with regard to a ligand refers to an unshared electron pair, a negative charge, or atoms or functional groups cable of forming an unshared electron pair or negative charge (e.g., via deprotonation at a particular pH).

The terms “polymer” and “polymeric” refer to chemical structures that have repeating units (i.e., multiple copies of a given chemical substructure). Polymers can be formed from polymerizable monomers. A polymerizable monomer is a molecule that comprises one or more moieties that can react to form bonds (e.g., covalent or coordination bonds) with moieties on other molecules of polymerizable monomer. In some embodiments, each polymerizable monomer molecule can bond to two or more other molecules/moieties. In some cases, a polymerizable monomer will bond to only one other molecule, forming a terminus of the polymeric material.

The term “coordination polymer” as used herein refers to a polymer comprising repeating units of coordination complexes, e.g., wherein a single ligand comprises a group coordinatively bound to one metal ion or metal cluster and another group coordinatively bound to a second metal ion or metal cluster.

### II. General Considerations

Organic-inorganic hybrid sulfur-containing materials have shown promising physical properties in superconductors, thermoelectronics, and other applications. Of the possible dithiolene ligands for use in sulfur-containing coordination polymers, TTFtt (TTFtt=tetrathiafulva-lene-2,3,6,7-tetrathiolate) is attractive as it combines the properties of dithiolenes with the favorable electronic properties of tetrathiafulvalene (TTF).¹¹ The structure of TTFtt (with the structure of TTF indicated by the dotted rectangle) is shown in Scheme 1, below.

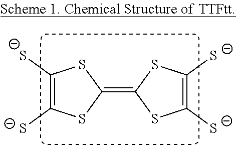 [SMILES: [S-]C1=C([S-])SC(=C2SC([S-])=C([S-])S2)S1]

A challenge to the incorporation of TTFtt into molecules or materials is the sensitivity (e.g., the air sensitivity) of both it and its synthons. Unprotected TTFttH₄ has not been isolated and characterized, although TTFttLi₄ can be generated transiently as a highly reactive and sensitive solid for metalations.¹⁴ The conventional synthetic technique for the incorporation of TTFtt involves the in situ deprotection of derivatives such as 2,3,6,7-tetrakis(2′-cyanoethyl-thio)tetrathiafulvalene TTFtt(C₂H₄CN)₄).¹⁶ This deprotection typically requires the use of an excess of strong base which limits the choice of solvent and also leads to undesirable side reactions due to the highly basic, nucleophilic, and reducing properties of the TTFtt⁴⁻ tetraanion. Furthermore, the required excess base can also introduce side-reactions. These issues have limited the investigation and incorporation of TTFtt to date.

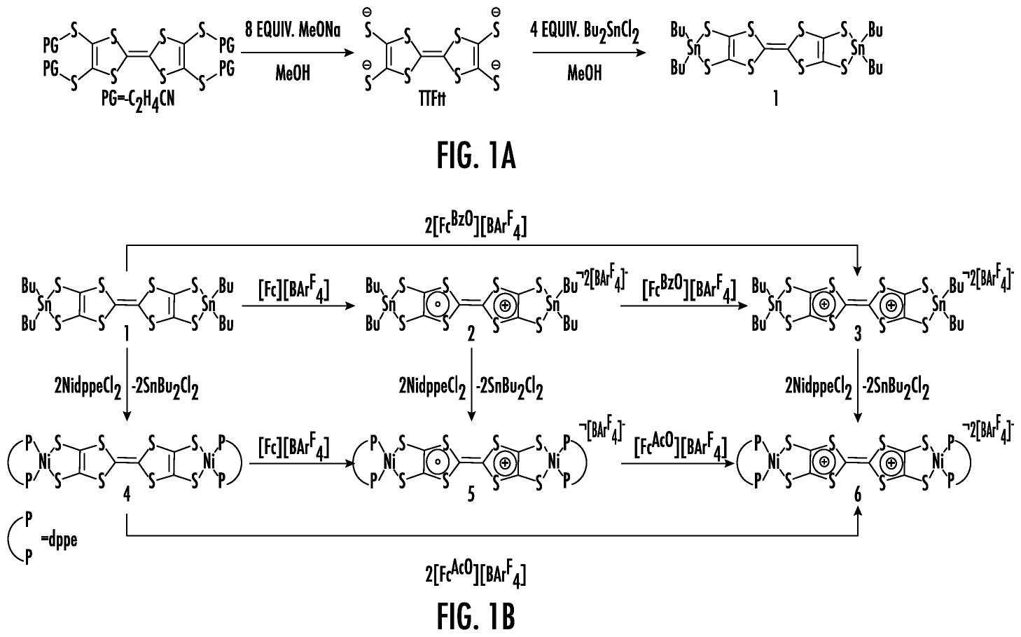

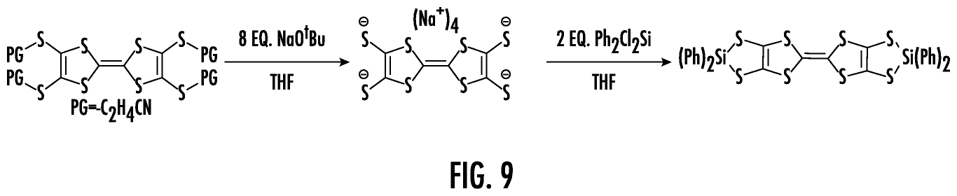

The presently disclosed and claimed subject matter provides TTFtt tin (Sn), silicon (Si), and germanium (Ge) complexes. The complexes can be used as reagents for transmetallation reactions, including in the preparation of electronically functional materials such as sulfur coordination polymers comprising TTFtt ligands. Exemplary complexes are shown in FIGS. 1A, 1B and 9. These exemplary complexes include extra hydrocarbon groups (i.e., alkyl, aralkyl, or aryl groups) on the Sn, Si, or Ge atoms, making the complexes soluble in common organic solvents and thereby offering more variety of material synthesis conditions. In addition, the complexes are isolable and more stable than conventional protonated/deprotonated forms of TTFtt reported in the literature. Furthermore, unlike other dithiolene tin agents, the presently disclosed agents are redox active and can be sequentially oxidized to generate stable cation radical and dicationic TTF cores in isolable complexes. Thus, the materials can be used for the synthesis of materials with different oxidation states. Such redox-control before materials synthesis can be referred to as “pre-synthetic redox reaction,” and provides for precise, controllable, and uniform doping for regulating the electronic structure of materials.

Accordingly, in some embodiments, the presently disclosed subject matter provides a coordination complex having a structure of Formula (I):

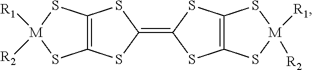

wherein M is selected from Si, Ge, and Sn; and R₁ and R₂ are independently selected from alkyl, aralkyl, and aryl. In some embodiments, M is Sn. In some embodiments, M is Si.

R₁ and R₂ can be any suitable hydrocarbon group. Thus, R₁ and R₂ can be unsubstituted alkyl, unsubstituted aralkyl, or unsubstituted aryl. In some embodiments, R₁ and R₂ are each C₁-C₆ alkyl (e.g., methyl, ethyl, n-propyl, isopropyl, n-butyl, isobutyl, n-pentyl, n-hexyl). In some embodiments, R₁ and R₂ are the same. In some embodiments, R₁ and R₂ are each butyl.

In some embodiments, at least one of R₁ and R₂ is aryl (e.g., phenyl). In some embodiments, R₁ and R₂ are each phenyl.

As noted hereinabove, the presently disclosed Sn, Ge, and Si coordination complexes are redox active. Thus, in some embodiments, the presently disclosed subject matter provides a coordination complex comprising (a) an oxidation product of the coordination complex having a structure of Formula (I):

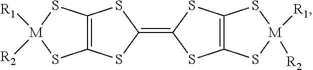

wherein M is selected from Si, Ge, and Sn; and R₁ and R₂ are independently selected from alkyl, aralkyl, and aryl; wherein said oxidation product comprises a cation radical or a dication (i.e., a cation radical or dication of the TTFtt ligand), and (b) an anionic species. The cation radical and dications complexes can have the structures:

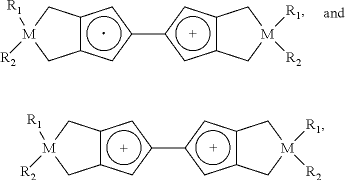

respectively.

The anionic species can be any suitable counterion. In some embodiments, the anionic species is a borate anion (e.g., tetrafluoroborate). In some embodiments, the anionic species is a borate anion comprising four aryl or substituted aryl or groups (e.g., a fluoroaryl or a (perfluoroalkyl)aryl group), such as, but not limited to tetrakis(3,5-bis(trifluoromethyl)phenyl) borate (i.e., BAr^{F}₄). In some embodiments, the anionic species is hexafluorophosphate (PF₆⁻). Other anionic species, including but not limited to triflate (i.e., CF₃SO₃⁻ (OTf)) or hexafluoroantimonate (SbF₆), can be used.

In some embodiments, the presently disclosed subject matter provides a mixture of TTFtt ligands having different oxidation states. For example, in some embodiments, the mixture can comprise at least two of (i.e., two of or all three of) TTFtt, a cation radical thereof, and a dication thereof. In some embodiments, one or more of the ligands in the mixture is provided as a Sn, Si, or Ge coordination complex. The ratio of the different ligands can be predetermined to provide a particular level of one or more of the ligands in the mixture.

The presently disclosed Sn, Si, and Ge coordination complexes can be used as reagents to provide other compositions comprising TTFtt ligands via transmetallation reactions. These other compositions can include other coordination complexes (i.e., coordination complexes with metals other than Sn, Ge, and Si, such as transition metals or alkaline earth metals), as well as coordination polymers. Thus, in some embodiments, the presently disclosed subject matter provides a method of preparing a coordination polymer, wherein the method comprises: (a) providing a first coordination complex having a structure of Formula (I):

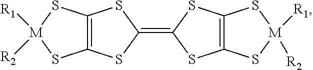

wherein: M is a first metal selected from Si, Ge, and Sn; and R₁ and R₂ are independently selected from alkyl, aralkyl, and aryl; and (b) contacting the first coordination complex from (a) with a second coordination complex comprising a second metal M′, wherein M′ is a transition metal, thereby forming a coordination polymer comprising repeating coordination complexes comprising M′ and a tetrathiolate ligand (e.g., TTFtt). In some embodiments, the first coordination complex from (a) can be contacted with more than one second coordination complex comprising a second metal M′, wherein each complex comprises a different second metal.

M′ can be any suitable transition metal or combination of metals, for example, selected from the group including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium, (Re), osmium (Os), iridium (Ir), platinum (Pt), and gold (Au). In some embodiments, M′ is selected from the group including Fe, Cr, Mo, Ni, W, Co, Cu, and Mn. In some embodiments, the complex comprising M′ is a metal cluster comprising M′. In some embodiments, the metal cluster is a metal sulfur cluster. In some embodiments, the metal cluster is a Mo-sulfur cluster.

In some embodiments, the method further comprises contacting the complex of Formula (I) with an oxidant prior to or during step (b). Thus, in some embodiments, the complex of Formula (I) is converted to a complex comprising the cation radical or dication of the TTFtt ligand prior to polymerization with the metal complex comprising M′. Thus, in some embodiments, the coordination polymer comprises repeating coordination complexes comprising M′ and an oxidation product of TTFtt.

In some embodiments, the presently disclosed subject matter provides a method of preparing a coordination polymer, wherein the method comprises: (a) providing at least two first coordination complexes, wherein each of said first coordination complexes is selected from (i) a coordination complex having a structure of Formula (I):

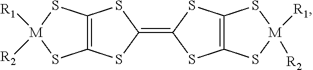

wherein: M is a first metal selected from Si, Ge, and Sn; and R₁ and R₂ are independently selected from alkyl, aralkyl, and aryl; (ii) a cation radical thereof; and (iii) a dication thereof; and (b) contacting the at least two first coordination complexes from (a) with a second coordination complex comprising a second metal M′, wherein M′ is a transition metal, thereby forming a coordination polymer comprising repeating coordination complexes comprising M′ and at least two of TTFtt, the cation radical of TTFtt and the dication of TTFtt. In some embodiments, the at least two first coordination complexes from (a) can be contacted with more than one second coordination complex comprising a second metal M′, wherein each complex comprises a different second metal. The relative amounts of the at least two first coordination complexes can be predetermined to achieve a particular level of cation radical and/or dication doping in the coordination polymer.

The presence of the cation radical or dication can increase the conductivity of the resulting coordination polymer. Thus, in some embodiments, the presently disclosed methods provide a coordination polymer with improved conductivity compared to a coordination polymer formed by contacting a coordination complex of Formula (I) with a coordination complex comprising a second metal M′ without contacting the coordination complex of Formula (I) with one or more oxidant prior to or during the contacting with the coordination complex comprising the second metal M′ and/or compared to the coordination polymer formed by contacting only the coordination complex of Formula (I) with a coordination complex comprising a second metal M′. In some embodiments, the conductivity is improved by about 50 times or more, about 100 times or more, about 200 times or more, about 500 times or more or by about 1000 times. In some embodiments, the conductivity can be controlled by controlling the ratio of the TTFtt-based coordination complexes (i.e., the coordination complex of Formula (I), the cation radical thereof, and/or the dication thereof) used to contact the coordination complex comprising the second metal M′. In some embodiments, the conductivity can be controlled by controlling the amount of oxidant.

Any oxidant that can oxidize TTFtt can be used. In some embodiments, the oxidant is a ferrocenium compound, such as acetyl ferrocenium or benzoyl ferrocenium compound. In some embodiments, the ferrocenium compound is a salt of a borate anion, such as one of the borate anions described above. For instance, in some embodiments, the borate anion is tetrakis(3,5-bis(trifluoromethyl)phenyl) borate. Other suitable oxidants include, but are not limited to, silver(I) salts. In some embodiments, the complex of Formula (I) is contacted with at least one equivalent of the one or more oxidant (e.g., about 1.0, about 1.1, or about 1.2 equivalents of oxidant). In some embodiments, the complex of Formula (I) is contacted with about 1.5 equivalents of oxidant. In some embodiments, the complex of Formula (I) is contacted with about 2.0 or 2.1 equivalents of oxidant.

In some embodiments, the contacting is performed in the presence of a modulating agent that can affect the crystallinity of the coordination polymer. The molar excess of the modulating agent can be used compared to the complex of Formula (I). For example, at least 5, 10, 25, 50, 75, 100, 200, 300, or 400 equivalents or more of the modulating agent can be used compared to the amount of the complex of Formula (I).

In some embodiments, the modulating agent is thiophenol. However, the modulating agent can be any suitable compound that can act as a competing ligand for M′. Other suitable modulating agents include, but are not limited to, an alkali or alkaline earth salt (e.g., a lithium salt), another thiol (i.e., other than thiophenol), a carboxylic acid, an amine, and nitrogen-containing heterocycles (e.g., pyridine).

In some embodiments, the presently disclosed subject matter provides a coordination polymer prepared by the presently disclosed methods. Thus, in some embodiments, the presently disclosed subject matter provides a coordination polymer comprising repeating coordination complexes comprising (i) a transition metal or a transition metal cluster and (ii) tetrathiafulvalene-2,3,6,7-tetrathiolate (TTFtt) and/or an oxidation product thereof, wherein said repeating coordination complexes extend in one, two or three dimensions. In some embodiments, the transition metal is selected from Fe, Cr, Mo, Ni, W, Co, Cu, and Mn. In some embodiments, the polymer comprises a transition metal cluster. In some embodiments, the transition metal cluster is metal sulfur cluster. In some embodiments, the transition metal cluster is a Mo sulfur cluster.

In some embodiments, coordination polymer has a conductivity that is greater than about 0.0001 S/cm. In some embodiments, the coordination polymer has a conductivity that is greater than about 0.0001 S/cm and about 0.22 S/cm or less.

In some embodiments, the presently disclosed subject matter provides a method of doping a coordination polymer. The doping can provide precise control over the electronic structure of the coordination polymer, e.g., by providing controlled levels of ligands having different oxidation states. In some embodiments, the method comprises: (a) providing a mixture of at least two different types of ligands selected from the group comprising TTFtt, a cation radical thereof, and a dication thereof; and (b) contacting the mixture of ligands with a transition metal M′. In some embodiments, the mixture in (a) includes two different types of ligands selected from TTFtt, a cation radical thereof, and a dication thereof (e.g., TTFtt and one of the cation radical or the dication thereof). In some embodiments, the mixture includes all three types of ligands. The mixture of ligands can comprise a predetermined ratio of the at least two different types of ligands, wherein the ratio is predetermined to achieve a desired doping level of oxidation states in the coordination polymer. In some embodiments, at least one of the at least two different types of ligands is provided in the form of a tin, silicon, or germanium coordination complex. In some embodiments, each of the at least two different types of ligands is provided as a tin, silicon or germanium coordination complex.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### General Methods

All manipulations were performed under an inert atmosphere of dry N₂ using a Schlenk line or MBraun UNIlab glovebox (MBraun, Stratham, N.H., United States of America) unless otherwise noted. 1H-NMR measurements were per-formed on Bruker DRX 400 or 500 spectrometers (Bruker, Billerica, Mass., United States of America). Elemental analyses (C, H, N) were performed by Midwest Microlabs (Indianapolis, Ind., United States of America). Acetone was sparged with N₂ and stored in the glovebox over CaSO₄. MeOH was dried with NaOH overnight, distilled, transferred into the glovebox and stored over 4 Å molecular sieves. All other solvents used in molecular synthesis were initially dried and purged with N₂ on a solvent purification system from Pure Process Technology (Nashua, N.H., United States of America). THF was further stirred with liquid NaK alloy and then filtered through activated alumina and stored over 4 Å molecular sieves. Other solvents were passed through activated alumina and stored over 4 Å molecular sieves. Unless noted, all other chemicals were purchased from commercial sources and used as received. TTFttPG (PG=—C₂H₄CN),¹⁶ dppeNiCl₂³¹ and [Fc][BAr^{F}₄]³² were prepared as previously described. [Fc^{AcO}][BAr^{F}₄] and [Fc^{BzO}][BAr^{F}₄] were prepared using the same synthetic method as [Fc][BAr^{F}₄] but stirred at room temperature instead of boiling DCM during [BAr^{F}₄] anion exchange to avoid decomposition of Fc^{AcO} or Fc^{BzO} cations.

[TEA]₂[Mo₃S₇Br₆] was synthesized as previously described.^{5f}

Compounds 3, 5, and 6 can be prepared via multiple approaches. The primary bulk procedure used for the studies described herein is described in detail below in Example 1, while alternative approaches are described briefly with product formation verified by NMR spectroscopic monitoring of the reactions.

### Example 1

### Synthesis of Sn and Ni Capped TTFtt Complexes

TTFtt(SnBu₂)₂(1)

TTFtt(C₂H₄CN)₄ (11 mmol, 5.9 g) and NaOMe (86.4 mmol, 4.75 g) were added into a 500 mL Schlenk flask with dry MeOH (27 mL) in a N₂-filled glovebox. The resulting suspension was stirred at room temperature overnight until all solids disappeared and a homogeneous dark red solution was observed. This solution was transferred into a sealed Schlenk flask and brought outside the glovebox. Volatiles were then removed under vacuum. Note that the higher vacuum from a Schlenk line is required to remove the volatile byproducts of the deprotection. When the solution was dried, the Schlenk flask was sealed and transferred back into the glovebox. The remaining solid was re-dissolved in MeOH (144 mL) and treated with Bu₂SnCl₂ (43.2 mmol, 13.1 g) in MeOH (36 mL). After the mixture was stirred over an additional night at room temperature, MeOH was removed again under Schlenk line vacuum. The remaining solid was extracted with DCM and filtered sequentially through Celite and silica. After flash silica chromatography with DCM or THF, all of the filtrate was collected and dried under vacuum to provide red solid. The crude solid was washed with 10 mL of cold acetone and dried under vacuum to yield 1 as a pink powder (3.5 g, yield: 41%). Crystals were prepared by either re-crystallization from boiling MeCN followed by cooling to −35° C. or DCM/Et₂O vapor diffusion overnight at −35° C. Crystals suitable for single crystal XRD were selected from the MeCN re-crystallization. ¹H NMR (400 MHz, CDCl₃, 298 K): δ 0.94 (3H, t, J=0.94 Hz), 1.38 (2H, q, J=1.38 Hz), 1.76 (4H, m, J=1.75 Hz) ppm. ¹¹⁹Sn{¹H} NMR (149 MHz, CDCl₃, 298 K): δ 220.89 ppm. ³C{¹H} NMR (126 MHz, CD₂Cl₂, 298 K) δ 13.61, 24.89, 26.77, 28.14, 111.59, 117.89 ppm. UV-vis-NIR (DCM, nm): 328.5, 515.6. IR (Nujol, KBr plates, cm⁻¹): 2724 (m), 2668 (m), 1304 (m), 1288 (m), 1242 (w), 1173 (m), 1146 (m), 1075 (m), 1016 (w), 979 (m), 966 (w), 936 (w), 885 (s), 866 (m), 846 (w), 773 (s), 722 (s), 666 (m). Anal. calc. for 1.MeCN, C₂₄H₃₉NS₈Sn₂: C, 34.50%, H, 4.71%, N, 1.68%; found: C, 33.51%, H, 4.75%, N, 0.99%.

[TTFtt(SnBu₂)₂][BAr^{F}₄] (2)

1 (0.03 mmol, 24 mg) was treated with [Fc][BAr^{F}₄] (0.027 mmol, 28 mg) in Et₂O (1 mL). After stirring for 10 mins, the solution was filtered through Celite and concentrated to about 0.5 mL volume. Petroleum-ether (4 mL) was added dropwise leading to the formation of a brown precipitate. The yellow PE supernatant was decanted gently. The solid was washed with fresh petroleum-ether and dried under vacuum to provide 2 as a brown solid (35 mg, 78%). Suitable crystals for single crystal XRD were obtained by Et₂O/PE layered diffusion at −35° C. for 3 days. UV-vis-NIR (DCM, nm): 384.1, 428.6, 465.4, 490.8, 591.0, 1053.7. IR (Nujol, KBr plates, cm⁻¹): 3174 (m), 2728 (m), 1650 (m), 1608 (w), 1309 (s), 1276 (s), 1110 (bs), 1003 (w), 966 (w), 887 (m), 848 (m), 838 (m), 818 (w), 769 (w), 741 (m), 720 (s), 680 (m), 668 (m). EPR (THF, 15K, 9.63 GHz, 6 μW): g_{eff}=2.008. Anal. calc. for 2, C₅₄H₄₈BF₂₄S₈Sn₂: C, 39.13%, H, 2.92%, N, 0%; found: C, 38.85%, H, 3.03%, N, 0%.

[TTFtt(SnBu₂)₂][BAr^{F}₄]₂ (3)

Compound 1 (24 mg, 0.03 mmol) was treated with [Fc^{BzO}][BAr^{F}₄] (0.066 mmol, 76 mg) in THF (1 mL). After stirring for 5 mins, the dark green solution was filtered through Celite and concentrated to about 0.5 mL volume. Petroleum-ether (4 mL) was added dropwise leading to the formation of a dark green oil-like precipitate and the orange supernatant was decanted gently. The precipitate was washed with fresh petroleum-ether (2 mL) for 3 times, redissolved in THF (1 mL), and reprecipitated by adding petroleum-ether (4 mL). The petroleum-ether supernatant was removed and the solid was washed with fresh petroleum-ether 3 times and dried under vacuum. The green solid was then collected and recrystallized from THF/petroleum-ether layered diffusion at −35° C. for 2 days to obtain 3 as dark green-brown crystals (56 mg, 74%). The resulting crystals are suitable for single crystal XRD. ¹H NMR (400 MHz, CDCl₃, 298 K): δ 0.94 (3H, bt), 1.42 (2H, bs), 1.77 (4H, bs), 1.98 (s, THF adduct), 3.87 (s, THF adduct), 7.52 (s, [BAr^{F}₄]⁻), 7.72 (s, [BAr^{F}₄]⁻) ppm. ¹¹⁹Sn{¹H}NMR (149 MHz, CDCl₃, 298 K): δ −192.70 ppm. ¹³C{¹H} NMR (126 MHz, CD₂Cl₂, 298 K) δ 13.52, 26.83, 28.07, 117.95 (m, [BAr^{F}₄]⁻), 125.04 (q, [BAr^{F}₄]⁻), 129.36 (q, [BAr^{F}₄]⁻), 162.21 (q, [BAr^{F}₄]⁻) ppm. UV-vis-NIR (DCM, nm): 469.5, 940.5. IR (Nujol, KBr plates, cm⁻¹): 2723 (w), 2666 (w), 1651 (s), 1608 (m), 1352 (s), 1278 (s), 1237 (w), 1119 (bs), 886 (m), 839 (m), 742 (m), 721 (m), 682 (m), 670 (m). Anal. calc. for 3.2THF, C₉₄H₇₆B₂F₄₈O₂S₈Sn₂: C, 42.36%, H, 2.87%, N, 0%; found: C, 41.91%, H, 3.05%, N, none. Note that the ¹H NMR spectrum of crystalline 3 in CDCl₃ shows broad peaks and uneven splitting patterns which suggests a small amount of radical 3 present. Similarly, the TTF peaks in the ¹³C NMR are not visible, again likely due to ex-change with some small amount of a radical species.

If the same reaction is finished in Et₂O instead of THF, then the product is dark purple throughout the workup and 3.2Fc^{BzO} is obtained as dark purple crystals from an Et₂O/petroleum ether layered diffusion at −35° C. for 3 days. Transmetalation of 3.2Fc^{BzO} is also facile as judged by ¹H NMR.

Alternative method: Compound 3 can also be generated by oxidation of 2 with 1.1 equivalents of [Fc^{BzO}][BAr^{F}₄] in THF and purified as described above.

(dppeNi)₂TTFtt (4)

dppeNiCl₂ (0.2 mmol, 105 mg) was dissolved in DCM (3 mL) and mixed with 1 (0.1 mmol, 80 mg) in DCM (3 mL) and then stirred for 15 mins. The yellow-orange precipitate was separated by centrifugation (additional THF can help the separation). The solid was washed with THF (3 mL) 3 times and dried under vacuum. 4 was obtained as an orange powder (115 mg, 93%). IR (Nujol, KBr plates, cm⁻¹): 2724 (w), 2671 (w), 1305 (m), 1185 (w), 1159 (w), 1101 (m), 1073 (w), 1025 (w), 996 (w), 971 (w), 907 (m), 873 (w), 820 (w), 764 (w), 744 (m), 690 (s), 649 (m). Anal. calc. for 4, C₅₈H₄₈Ni₂P₄S₈: C, 56.05%, H, 3.89%, N, 0%; found: C, 55.79%, H, 4.11%, N, 0%.

[(dppeNi)₂TTFtt][BAr^{F}₄] (5)

Compound 4 (0.03 mmol, 37.2 mg) was treated with [Fc][BAr^{F}₄] (0.027 mmol, 29 mg) in DCM (3 mL) and stirred for 10 mins. After filtration through Celite, the filtrate was concentrated to about 0.5 mL and slow addition of petroleum-ether (4 mL) caused a brown precipitate to form. The petroleum-ether supernatant was removed and the precipitate was washed with fresh petroleum-ether 3 times and dried under vacuum to pro-vide 5 as a brown solid (50 mg, 88%). Brown crystals were obtained via PhCl/petroleum-ether vapor diffusion at room temperature for one day (32 mg, 57%). ¹H NMR (400 MHz, CDCl₃, 298 K): δ 2.44 (bs, dppe), 7.51 (s, [BAr^{F}₄]⁻), 7.61 (bs, dppe), 7.63 (bs, dppe), 7.71 (s, [BAr^{F}₄]⁻), 8.00 (bs, dppe) ppm. UV-vis-NIR (DCM, nm): 429.9, 457.4, 491.1, 570.3, 1268.4. IR (Nujol, KBr plates, cm⁻¹): 2721 (w), 2664 (w), 1274 (s), 1118 (bs), 1098 (m), 1028 (w), 998 (w), 968 (w), 932 (w), 878 (m), 838 (m), 817 (w), 772 (w), 743 (m), 680 (m). Evans method (CDCl₃, room temperature): μeff=1.19 Bohr magnetons (B.M.). EPR (THF, 15K, 9.63 GHz, 0.2 μW): geff=2.013, 2.007, 2.003. Anal. calc. for 5, C₉₀H₆₀BF₂₄Ni₂P₄S₈: C, 51.33%, H, 2.87%, N, 0%; found: C, 51.64%, H, 2.98%, N, 0%.

Alternative method: Complex 5 was also prepared through the metalation of 2 with 2 equivalents of dppeNiCl₂ in DCM as indicated by ¹H NMR spectra.

[(dppeNi)₂TTFtt][BAr^{F}₄]₂ (6)

To simplify the synthesis, 3 was generated in situ and used directly for the preparation of 6. Compound 1 (0.01 mmol, 8 mg) was treated with [Fc^{BzO}][BAr^{F}₄] (0.022 mmol, 25 mg) in Et₂O (0.5 mL). The resulting dark purple solution was added to dppeNiCl₂ (11 mg, 0.02 mmol) which over 3 mins resulted in the dissolution of the yellow dppeNiCl₂. The solution was then filtered through Celite and concentrated to about 0.5 mL volume. Petroleum-ether (4 mL) was added to the resulting dark purple solution to precipitate the product. After gently removing the orange supernatant and washing with fresh petroleum-ether several times, the purple-red powder was dried under vacuum. Compound 6 can then be obtained as purple-red crystals by PhCl/petroleum-ether vapor diffusion at room temperature for 2 days (24 mg, 81%). ¹H NMR (400 MHz, CDCl₃, 298 K): δ 2.47 (d, dppe), 7.48 (s, [BAr^{F}₄]⁻), 7.50-7.60 (m, dppe), 7.61-7.70 (m, dppe), 7.70 (s, [BAr^{F}₄]⁻) ppm. ³¹P{¹H} NMR (162 MHz, CDCl₃, 298 K): δ 62.95 ppm. 3C{¹H}NMR (126 MHz, CD₂Cl₂, 298 K) δ 27.00 (t, dppe), 117.95 (m, [BAr^{F}₄]⁻), 125.04 (q, [BAr^{F}₄]⁻), 126.79 (t, dppe), 129.36 (q, [BAr^{F}₄]⁻), 130.10 (t, dppe), 133.53 (s, dppe), 133.71 (t, dppe), 156.09 (s, TTFtt), 162.21 (q, [BAr^{F}₄]⁻), 173.46 (s, TTFtt) ppm. UV-vis-NIR (DCM, nm): 515.6, 1039.5. IR (Nujol, KBr plates, cm⁻¹): 2723 (w), 2670 (w), 2585 (w), 1354 (s), 1277 (s), 1119 (bs), 999 (w), 958 (m), 878 (m), 839 (m), 816 (w), 745 (m), 682 (m). Anal. calc. for 6, C₁₂₂H₇₂B₂F₄₈Ni₂P₄S₈: C, 49.35%, H, 2.44%, N, 0%; found: C, 49.02%, H, 2.69%, N, 0%.

Alternative method 1: Complex 6 can be obtained by direct metalation of isolated 3 or 3.2Fc^{BzO} with 2 equivalents of dppeNiCl₂. The products were verified by ¹H NMR spectra.

Alternative method 2: 6 was also prepared by oxidation of 4 with 2 equivalents [Fc^{AcO}][BAr^{F}₄] or 5 with 1 equivalent [Fc^{AcO}][BAr^{F}₄] in Et₂O and the purification is the same as above.

### Discussion

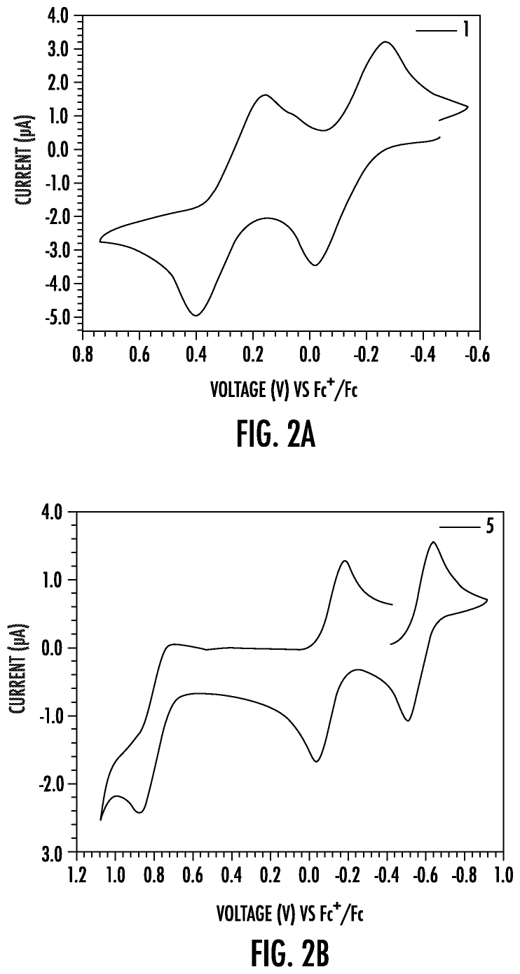

The reactions involved in Example 1 are summarized in FIGS. 1A and 1B. Compound 1 was synthesized via deprotection of TTFtt(C₂H₄CN)₄ with excess sodium methoxide and subsequent reaction with excess Bu₂SnCl₂ in methanol. In contrast to the high reactivity of the TTFtt⁴ tetraanion, 1 was indefinitely stable as a solid at room temperature and red crystals can be obtained via recrystallization from boiling acetonitrile at 80° C. The stability of 1 under these conditions suggests that the use of common solvothermal synthetic conditions for coordination polymers should be viable. The cyclic voltammogram (CV) of neutral 1 shows two quasi-reversible features, suggesting that two oxidized species are chemically accessible. See FIG. 2A. The reagents [Fc][BAr^{F}₄] and [Fc^{BzO}][BAr^{F}₄] (Fc⁺=ferrocenium, Fc^{BzO}=benzoyl ferrocenium) were therefore used to chemically access the singly and doubly oxidized redox congeners 2 and 3. While brown crystals of 2 were obtained which verified the proposed structure of this compound, the oxidation reaction of 1 with 2 equivalents of [Fc^{BzO}][BAr^{F}₄] under the same conditions led to the formation of 3.2Fc^{BzO} where each Sn center is coordinated by an additional Fc^{BzO} molecule. To avoid the formation of these adducts, the reaction and crystallization were both conducted in THF solvent which enabled the isolation of green crystals of 3.2THF.

The ability of these stanylated species for ligand transmetalation was tested by reactions with 2 equivalents of dppeNiCl₂ in dichloromethane or Et₂O at room temperature. All metalation processes proceed smoothly and provide the three corresponding dinickel complexes, 4-6, in good yield. Complex 4 with a formally neutral TTF core was obtained as an insoluble orange-yellow powder. Compounds 5 and 6, however, were much more soluble enabling crystallization as dark brown and purple crystals respectively. The Ni complexes are also redox-active as indicated by their CV's which show two quasi-reversible oxidations shifted ˜0.4 V more negative than those observed in 1. See FIG. 2B. Compounds 5 and 6 could also be generated by oxidizing 4 with [Fc][BAr^{F}₄] and [Fc^{AcO}][BAr^{F}₄] (Fc^{AcO}=acetyl ferrocenium) respectively as verified by NMR spectroscopy.

These compounds demonstrate that the stanylation of the reactive and unstable TTFtt⁴ anion is an effective strategy to both stabilize unusual redox species as well as to enable facile transmetalation to transition metals. These tin agents are more stable than conventional in situ formed TTFtt⁴ anions, allowing for purification, long-term storage, and convenient utility under a wide range of conditions with various solvents. In addition to these advantages, complexes 2 and 3 provide additional synthetic flexibility via controlled redox “doping.” For instance, complex 2, with a TTF radical cation core, enables direct insertion of radical linkers between metal centers. Furthermore, 3 is one of only a few examples of isolable dicationic TTF motifs.^{17,18} The facile redox and transmetalation chemistry of 1-3 paves the way for the synthesis of new materials with precisely tuned redox states.

### Example 2

### Solid State Structures

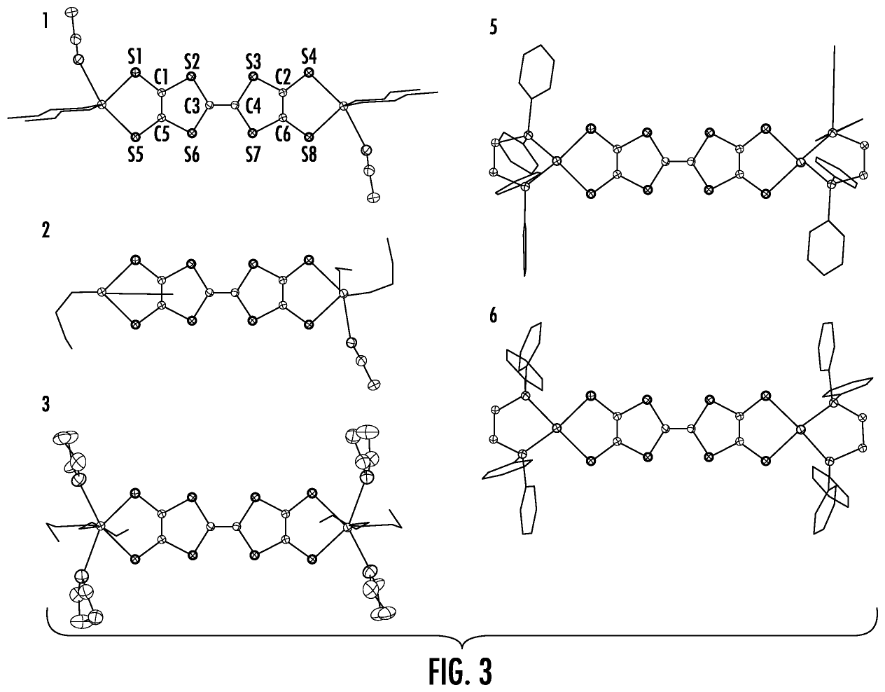

Compounds 1-3, 5, and 6 were crystallographically characterized and their single crystal X-ray diffraction (SXRD) structures are shown in FIG. 3. Compounds 1, 3, and 5 crystallize in the triclinic space group P-1, compounds 2 and 6 crystallize in the monoclinic space groups P21/c and C₂/c, respectively. The geometrical parameters of the TTF cores such as bond lengths and dihedral angles are typically sensitive to the redox state of the TTF unit.^{17f} Interestingly, in the present Sn capped redox series some of these changes are muted. For instance, planarization of the TTF core is typically observed only upon oxidation, but in 1, the neutral TTF rings are nearly coplanar. The trends in the C—C and C—S bond lengths are more informative and are shown in Table 1, below. As the molecular charge increases, the C—C bond distances in the TTF cores also increase, while the C—S bond lengths generally decrease. These trends are consistent for both the Sn series in 1-3 and the Ni series from 5 to 6. These changes are consistent with previous studies showing similar geometric trends upon oxidation of TTF molecules.^{17f} Conversely, there is little change or trend in the M-S distances for either the Sn or the Ni complexes, supporting the assignment of primarily TTF-centered redox events.

TABLE 1
SXRD Metrical Parameters for 1-3, 5, and 6.

| | C3-C4 (A\check{o}) | C1,2-C5,6 (A\check{o}) | C-S (A\check{o})^{a} | M-S (A\check{o}) | M-S (A\check{o}) |
|---|---|---|---|---|---|
| 1 | 1.333(5) | 1.338(4) | 1.746(3)- | 2.4579(7) | 2.5050(7) |
| | | | 1.760(3) | | |
| 2^{b} | 1.351(16) | 1.37(2) | 1.72(1)- | 2.455(4) | 2.446(3)- |
| | | | 1.76(1) | | 2.563(3) |
| 3 | 1.436(18) | 1.402(12) | 1.681(9)- | 2.535(2) | 2.502(3) |
| | | | 1.732(8) | | |
| 5 | 1.385(2) | 1.361(2) | 1.726(2)- | 2.1616(5) | 2.1750(8) |
| | | | 1.740(1) | | |
| 6 | 1.412(5) | 1.379(3) | 1.704(2)- | 2.1684(7) | 2.1790(7) |
| | | | 1.726(2) | | |

^{a}C-S bonds include all C-S bonds in TTFtt linker.
^{b}The two five-membered rings of 2’s TTF core are not symmetric.

Most of these compounds also display intermolecular TTF-TTF packing interactions in their single crystal x-ray diffraction (SXRD) structures, as has been observed extensively in other TTF based systems.¹² Compounds 1, 5 and 6 show extended one dimensional chains via weak side-to-side sulfur-sulfur interactions, although another unusual additional polymorph of 5 was found as described more thoroughly below. Compound 2 forms dimers in the solid-state via π-stacking. Finally, dicationic 3 shows no significant intermolecular interaction as the TTF core is effectively shielded by the large [BAr^{F}₄] anions.

### Example 3

### Electronic Properties of Sn and Ni Complexes

As discussed above, CV shows two oxidation peaks for 1 at −0.14 V and 0.28 V vs. Fc+/Fc. In 5 these features shift to −0.58 V and −0.11 V respectively. The Ni species display an additional irreversible peak at 0.79 V vs Fc+/Fc which is tentatively assigned as a Ni(II) to Ni(III) oxidation. Redox events at similar potentials were seen for the complex (dpppNi)₂TTFtt (dppp=1,3-bis(di-phenylphosphino)propane) although isolation of this compound was not reported.^{14b} It is worth noting that appreciable film deposition at the working electrode surface was observed on repeated scans in the CV studies. Without being bound to any one theory, this is attributed to reaction of the oxidized congeners with the [PF₆]⁻ electrolyte anions. The CV of 5 with [Na][BAr^{F}₄] as the electrolyte medium was performed and no obvious degradation was observed over multiple scans. This enhanced stability from fluorinated aryl borates is also reflected in the synthetic chemistry mentioned above. The lack of oxidative features between 0 and 0.6 V suggests that the dicationic species 6 is potentially air-stable. To test this possibility, a CDCl₃ solution of 6 was exposed to air for 12 hours and then analyzed by NMR spectroscopy. Comparison of the ¹H and ³¹P NMR spectra before and after this exposure indicate nearly no decomposition with the exception of a very small amount of oxidized phosphine (<2%). While crude, this initial test indicates that materials composed of typically air-sensitive TTFtt synthons can be made air-stable by tuning the charge state of the TTF core.

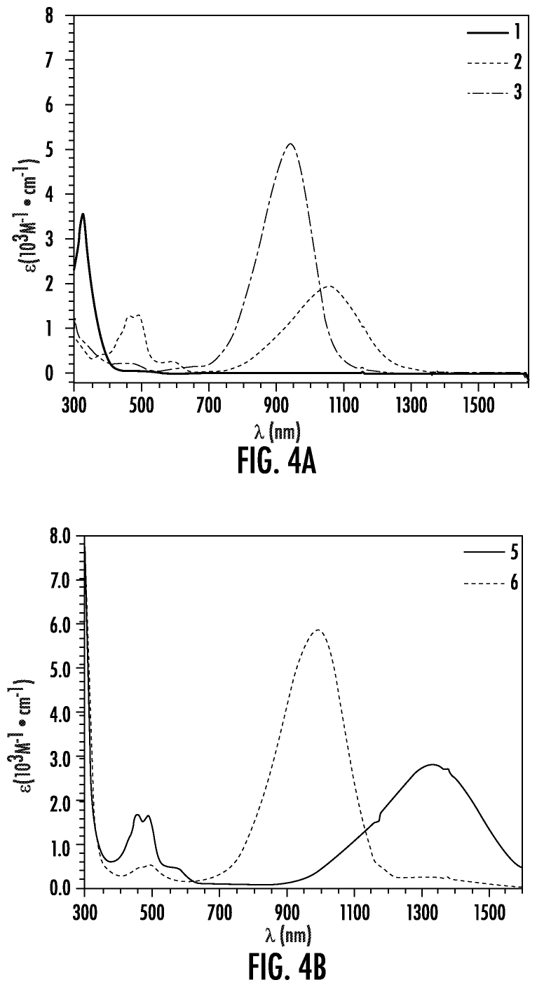

In order to more firmly assign the redox features observed by CV, UV-vis-NIR investigations were carried out on the Sn compounds 1-3 and on the soluble Ni complexes 5 and 6. See FIGS. 4A and 4B. Compound 1 has an intense feature at 328 nm, assigned as arising mainly from π-π* transitions.¹⁹ Upon oxidation to 2 a broad feature emerges at 1053 nm. Appearance of this new low-energy absorption band has been previously interpreted as arising from the formation of π-dimers.²⁰ This absorption band blue-shifts to 941 nm upon further oxidation. Similar spectral features are observed in the Ni complexes 5 and 6. See FIG. 4B. Compared to 2 and 3, the NIR absorption features of 5 and 6 both show a distinct red-shift.

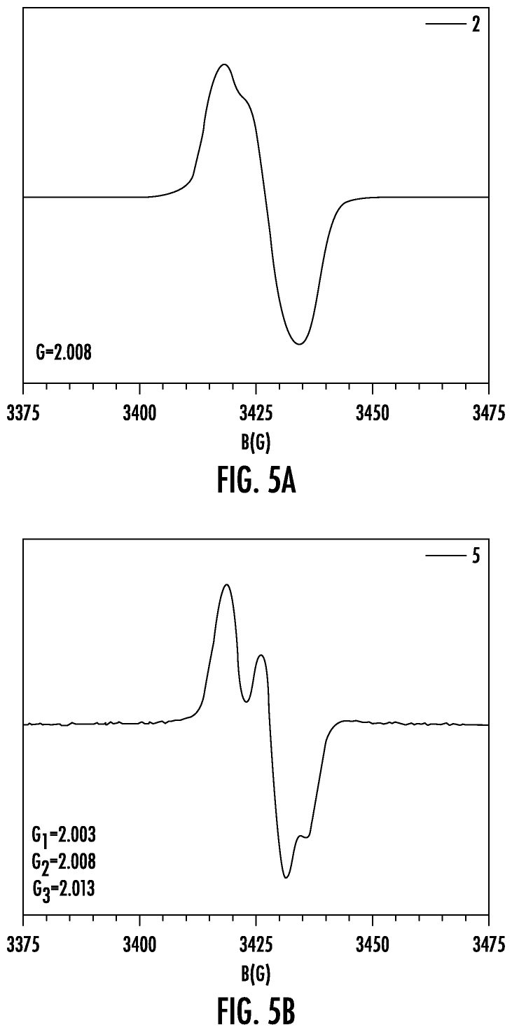

In addition to UV-vis-NIR spectra, the signals of the TTF radicals were investigated by EPR spectroscopy. The EPR spectrum of 2 in THF (see FIG. 5A) demonstrates a single line at g=2.008, consistent with an organic radical. Conversely, anisotropic signals at g=2.013, 2.007, and 2.003, were observed in the EPR spectrum of 5. See FIG. 5B. Similarly anisotropic signals have been observed in other TTF radical systems.²¹ The spectroscopic and structural data for these compounds is very similar to that observed for other TTF systems, again suggesting that the redox events of TTFtt are largely localized on the TTF core.

### Example 4

### Packing and Dimerization of TTFtt Units

Although the NIR absorptions indicate the presence of π-dimer formation in solution, this interpretation has been questioned.²² To probe the possibility of dimerization in solution, room temperature Evans method experiments on CDCl₃ solutions of 5 were performed. The experimentally measured magnetic moment μeff=1.19 B.M. is smaller than the predicted spin-only value of 1.73 B.M., suggesting that some degree of oligomerization is occurring. Additionally, spin quantitation of the EPR spectrum of 5 at 15 K indicates <10% of the expected signal based on the concentration of 5, also supporting some degree of dimerization.

In addition to these solution studies, the effect of the solid-state packing of these molecules was examined. Solid-state packing of TTF cores is well-known, and much of the bulk transport properties of TTF based systems arises from their π-π and sulfur-sulfur interactions in the solid state, particularly in single component conductors.^{11,12,13,23} The packing of these compounds has been discussed above and is largely similar to previously reported systems. Solid state magnetic measurements were performed on 5 and indicate a diamagnetic compound, which is also similar to previously re-ported radical cations of TTF.^{15,24}

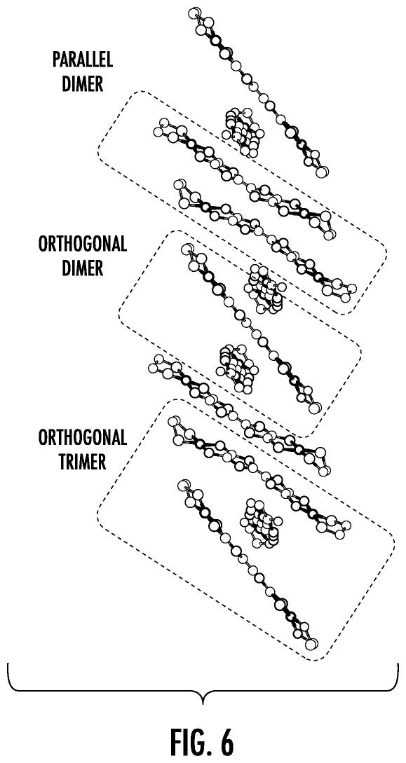

During the course of these studies, a poorly diffracting alternative polymorph of 5 was isolated. While the quality of this crystal prevented a full structural solution, sufficient resolution was obtained to observe a stacking interaction which has a twist of the TTF cores by a nearly orthogonal ˜90°. See FIG. 6. TTF stacking most commonly has a parallel arrangement, although there are examples of similar twisted interactions, particularly when supported by auxiliary polymeric superstructures.¹³ This structure of 5 is somewhat unusual in that the rotated 1 D column of 5 is composed of two elements: trimers with asymmetric orthogonally crossed interactions and dimers with more typical parallel interactions. See FIG. 6. The strength of TTF-TTF interactions and overlap is dependent on S—S interactions between TTF cores. In this polymorph of 5 however, these distances are quite similar between the orthogonal and parallel interactions which prompted investigation of what additional effect the twisting of the TTF-TTF cores has on their interaction.

Variational 2-electron reduced density matrix (V2RDM) techniques²⁵ have previously been demonstrated to successfully describe the electronic structure of a variety of strongly correlated large molecules.²⁶ Thus, to better understand the dimer and trimer units, V2RDM calculations were carried out as implemented in the Maple Quantum Chemistry Package.²⁷ The phenyl ligands were replaced with methyl groups and [18,20] active space V2RDM calculations with the 3-21G basis set were performed for both geometries providing the data shown in Table 2.²⁸ The electronic structures of both arrangements show significant degrees of correlation as demonstrated by partial occupancies in their frontier natural orbitals (NOs). The orthogonal arrangement shows more radical character, with frontier orbital natural occupation numbers (NON) of 1.224860 and 0.771141 suggesting significant bi-radical character, compared to 1.49923 and 0.51331 in the parallel arrangement. Mulliken charges show an effective oxidation state of +½ for the Ni centers in both geometries, with a slightly higher cumulative charge of 1.94745 in the parallel arrangement compared to 1.70585 in the orthogonal system.

TABLE 2
NO occupations (λ) and Ni atom Mulliken charges (q) for the dimer and
trimer units. V2RDM calculations were performed with a [18,20] active
space for the dimer and a [17,20] active space for the trimer with a
3-21G basis set.

| Dimer | | | | |
|---|---|---|---|---|
| | Parallel | Orthogonal | Trimer | |
| λ382 | 1.88571 | 1.912486 | λ573 | 1.92977 |
| λ383 | 1.49923 | 1.224860 | λ574 | 1.32748 |
| λ384 | 0.51331 | 0.771141 | λ575 | 0.97218 |
| λ385 | 0.08481 | 0.073175 | λ576 | 0.64935 |
| q1 | 0.40607 | 0.37830 | λ577 | 0.06524 |
| q2 | 0.56836 | 0.43482 | q1 | 0.44168 |
| q3 | 0.57037 | 0.45403 | q2 | 0.44892 |
| q4 | 0.40265 | 0.43870 | q3 | 0.43547 |
| | | | q4 | 0.43356 |
| | | | q5 | 0.44406 |
| | | | q6 | 0.43699 |

Frontier orbital densities, occupations and splittings for the parallel dimer of the Ni complex of the cation radical of TTFtt, i.e., compound or complex 5, and the orthogonal dimer and trimer were calculated. All frontier NOs are localized on the bridging ligand with no involvement of the Ni centers. There are significant differences in the orbital configurations elucidating the variation in frontier NON across the two dimer arrangements. The larger splitting of the NO occupancy in the parallel arrangement appears to arise from better orbital overlap between the two monomers, allowing for greater energetic orbital splitting into NO 384 with significant antibonding character, showing no overlap between the two monomers, and NON 383 with significant bonding character and orbital overlap. In contrast, the orthogonal dimer shows two frontier NOs with similar densities, both showing significant bonding character and overlap between the two monomers, yielding a smaller splitting and correspondingly greater bi-radical character. Good overlap and correspondingly small splitting in the orthogonal dimer give way to a clear splitting into bonding, non-bonding, and antibonding frontier NOs upon transitioning into the orthogonal trimer. As the orthogonal dimeric arrangement is actually part of a larger asymmetrically stacked unit, a trimeric unit was run separately in V2RDM using a [17,20] active space and the 3-21G basis set, giving a SCF calculation with 1308 orbitals. Data are shown in Table 2. Similar to the dimeric case, the trimer unit exhibits radical character and three partially occupied NOs with NON of 1.32748, 0.97218 and 0.64935. Mulliken charges in this arrangement are particularly symmetric with each nickel showing a charge of 0.43 to 0.45 with very little variation between the individual centers. Transitioning from a dimeric to a trimeric unit gives rise to splittings and symmetries in line with a classic Hückel picture with the orbitals splitting into bonding, non-bonding and antibonding. The bonding and antibonding orbitals NO 574 and 576 both show roughly equal distribution of the electron density across all three units within the trimer. NO 574 has good matching of the phases between the orbitals localized on each of the units in the trimer leading to overlap between the orbitals on all units and giving rise to significant bonding character and a NO occupancy of 1.32748. Constituent orbitals of NO 576 in contrast constitute a worse matching of the phases, reducing overlap between the individual units and leading to an overall antibonding interaction and a NO occupancy of 0.64935. Singly occupied non-bonding NO 575 is localized on the top and bottom molecules with a nodal plane and negligible density on the central unit, leading to an electron entangled across the two isolated top and bottom units within the trimer.

The results from V2RDM CASSCF calculations help rationalize the appearance and stability of the different morphologies in the TTFtt stacks. Packing geometries in both the parallel and orthogonal arrangement allow for good orbital overlap between the individual units. Both morphologies show the frontier natural orbitals form via π-π stacking utilizing orbitals localized on the TTF linkers. The resulting NOs differ slightly between the different morphologies with overlap in the parallel geometry allowing for better splitting into clear bonding and antibonding frontier orbital pairs, reducing radical character. The splitting is less pronounced in the orthogonal dimer; however, as the chain size increases splitting into bonding, non-bonding and antibonding frontier orbital pairs is recovered in the trimer. In all cases partial occupations in the frontier NOs is retained, allowing for radical chain development and electron entanglement across multiple units.

In 1985, Hoffman and coworkers predicted possible stacking structures of metal bisdithiolenes based on qualitative molecular orbital and band structure calculations.²⁹ Soon afterwards, in 1988, a LAXS (Large Angle X-ray Scattering) and EXAFS (Extended X-ray Absorption Fine Structure) investigation was performed on amorphous nickel tetrathiolate polymers, proposing two types of polymers with hexagonal (honeycomb) and tetragonal packings for small and large cations, respectively.³⁰

However, the stackings of the TTFtt radicals in 5 highlight the role of strong intermolecular interactions between radicals in the control of morphology. In sum, the stabilization and synthetic access provided by the Sn capped compounds described herein enables the observation of a variety solid-state interactions of the TTF core. It is anticipated that the redox flexibility of these synthons can provide the observation of novel interactions and electronic structures in TTFtt based coordination polymers.

In summary, TTFtt is an attractive building block for redox-switchable and highly conjugated metal-organic materials. The capping of TTFtt with dialkyl Sn groups stabilizes the ligand and facilitates the use of redox-active TTFtt moieties. Furthermore, the redox flexibility of these synthons helps to precisely control doping, charge, and crystallinity via homogeneous molecular reactions. The synthesis and characterization of the corresponding dinickel complexes validates the ease of transmetallation as a synthetic strategy. An unusual “twisted” geometry in the solid state was observed, which can impact the electronic structure of the TTF-TTF interaction, effectively demonstrating the utility of these new synthons.

### Example 5

### Synthesis and Characterization of Sulfur Coordination Polymers

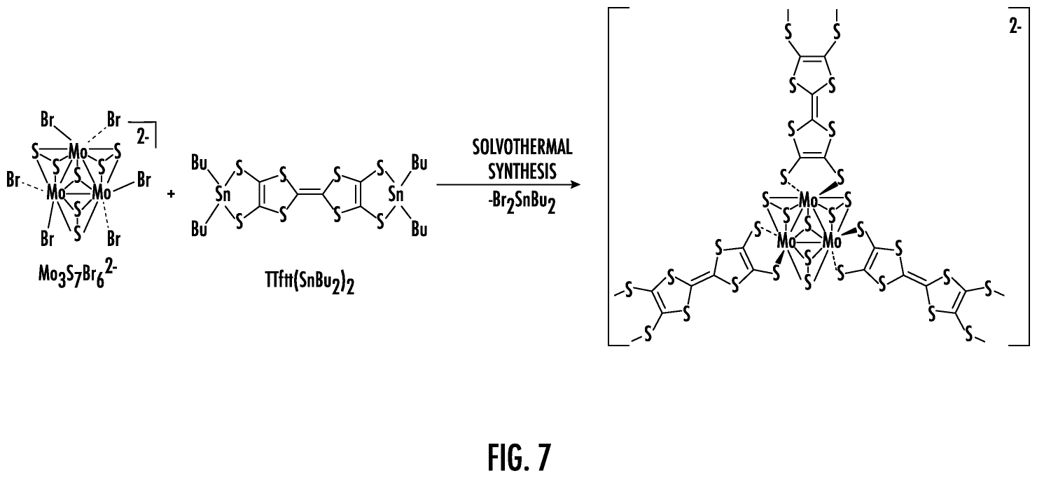

An exemplary method for preparing an exemplary sulfur coordination polymer comprising TTFtt ligands and Mo sulfur clusters is shown in FIG. 7. Pre-synthetically oxidizing the TTFtt-Sn agent used to prepare the polymer resulted in a 1000-fold improvement in conductivity. Table 3, below, shows the reaction conditions and conductivity measurements of coordination polymers prepared from non-oxidized Sn-TTFtt agents and oxidized Sn-TTFtt agents.

TABLE 3
Exemplary Coordination Polymers.

| Reaction | Conductivity (S/cm) |
|---|---|
| [TEA]₂[Mo₃S₇Br₆] + | 1.8 × 10⁻⁴ |
| 1.5 TTFtt(SnBu₂)₂ | |
| [TEA]₂[Mo₃S₇Br₆] + | 0.22 |
| 1.5 TTFtt(SnBu₂)₂ + 2 FcBAr^{F}₄ | |

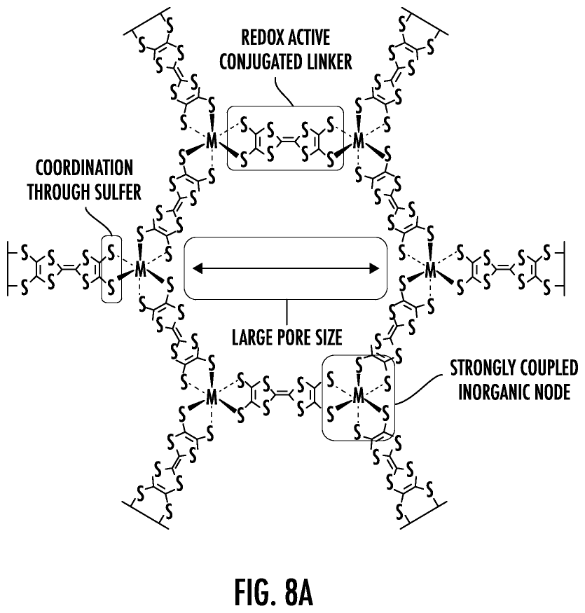

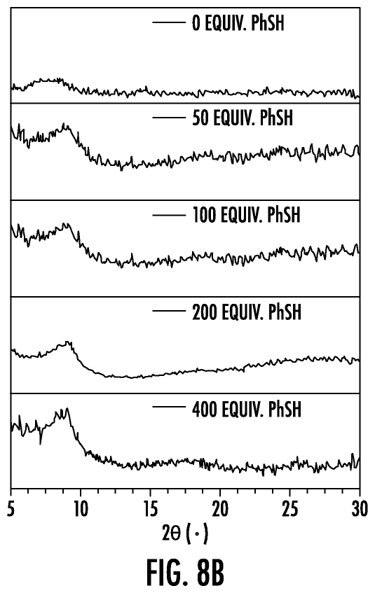

FIG. 8A shows a schematic drawing of the chemical structure of a coordination polymer comprising a metal ion M and TTFtt ligands. The identity of the M center can either be a single metal ion, such as Fe, Co, Cr, etc., or a metal cluster (e.g., comprising Fe, Co, Cr, etc.). In the present example, the metal cluster is Mo₃S₇. Preliminary results using this cluster with TTFtt ligands indicate the formation of an ordered solid. If desired, modulation agents, such as thiophenol (PhSH) can be added during preparation of this coordination polymer. As shown in FIG. 8B, coordination polymers prepared with increasing amounts of thiophenol appeared to show improved crystallinity compared to coordination polymers made without or with lower amounts of the modulating agent.

Additional exemplary syntheses of coordination polymers were performed as follows:

[TEA]₂[(Mo₃S₇)₂(TTFtt)₃]

Compound [TEA]₂[Mo₃S₇Br₆] (0.03 mmol, 38 mg) was added into a 24 mL vial and dissolved in warm DMF (3 mL). A solution of compound 1 (0.045 mmol, 35 mg) in warm DMF (2 mL) was added leading to a dark brown solution and the vial was sealed and placed in a heating block on a 140° C. hot plate. The reaction mixture was heated for 2 days, after which black powders was separated by centrifugation, washed with DMF (3×2 mL) and MeCN (3×2 mL), and dried under vacuum. [TEA]₂[(Mo₃S₇)₂(TTFtt)₃] was obtained as a black powder and the conductivity measurement was carried out on the powder pellets of as-synthesized materials.

(Mo₃S₇)₂(TTFtt)₃

Compound [TEA]₂[Mo₃S₇Br₆] (0.03 mmol, 38 mg) and [Fc][BAr^{F}₄] (0.02 mmol, 21 mg) were added into a 24 mL vial and dissolved in warm MeCN (3 mL). A red solution of compound 1 (0.045 mmol, 35 mg) in warm MeCN (2 mL) was added inviting a large amount of brown precipitate immediately and the vial was sealed and placed in a heating block on a 100° C. hot plate. The reaction mixture was heated for 2 days, after which brown powders was separated by centrifugation, washed with MeCN (4×2 mL), and dried under vacuum. (Mo₃S₇)₂(TTFtt)₃ was obtained as a brown powder and the conductivity measurement was carried out on the powder pellets of as-synthesized powder materials.

### Example 6

### Synthesis of TTFtt-Si Complexes

TTFtt-Si complexes can be prepared according to methods similar to that for the preparation of TTFtt-Sn complexes. See FIG. 9. For example, the bis-diphenylsilicon TTFtt can be prepared by treating TTFtt(C₂H₄CN)₄ with an excess of NaOMe and then treating the resulting solid with two equivalents of Ph₂Cl₂Si.

### REFERENCES

(1) Huang, X.; Zhang, S.; Liu, L.; Yu, L.; Chen, G.; Xu, W.; Zhu, D. Superconductivity in a Copper(II)-Based Coordination Polymer with Perfect Kagome Structure. Angew. Chemie Int. Ed. 2018, 57 (1), 146-150.
(2) (a) Wang, L.; Han, Y.; Feng, X.; Zhou, J.; Qi, P.; Wang, B. Metal-Organic Frameworks for Energy Storage: Batteries and Supercapacitors. Coord. Chem. Rev. 2016, 307, 361-381. (b) Sheberla, D.; Bachman, J. C.; Elias, J. S.; Sun, C.-J.; Shao-Horn, Y.; Dinc\check{a}, M. Conductive MOF Electrodes for Stable Supercapacitors with High Areal Capacitance. Nat. Mater. 2017, 16 (2), 220-224. (c) Wada, K.; Sakaushi, K.; Sasaki, S.; Nishihara, H. Multielectron-Transfer-Based Rechargeable Energy Storage of Two-Dimensional Coordination Frameworks with Non-Innocent Ligands. Angew. Chemie Int. Ed. 2018, 57 (29), 8886-8890. (d) Feng, D.; Lei, T.; Lukatskaya, M. R.; Park, J.; Huang, Z.; Lee, M.; Shaw, L.; Chen, S.; Yakovenko, A. A.; Kulkarni, A.; et al. Robust and Conductive Two-Dimensional Metal-organic Frameworks with Exceptionally High Volumetric and Areal Capacitance. Nat. Energy 2018, 3 (1), 30-36. (e) Park, J.; Lee, M.; Feng, D.; Huang, Z.; Hinckley, A. C.; Yakovenko, A.; Zou, X.; Cui, Y.; Bao, Z. Stabilization of Hexaaminobenzene in a 2D Conductive Metal-Organic Framework for High Power Sodium Storage. J. Am. Chem. Soc. 2018, 140 (32), 10315-10323.
(3) (a) Sun, Y.; Sheng, P.; Di, C.; Jiao, F.; Xu, W.; Qiu, D.; Zhu, D. Organic Thermoelectric Materials and Devices Based on P- and n-Type Poly(Metal 1,1,2,2-Ethenetetrathiolate)S. Adv. Mater. 2012, 24 (7), 932-937. (b) Jiao, F.; Di, C.; Sun, Y.; Sheng, P.; Xu, W.; Zhu, D. Inkjet-Printed Flexible Organic Thin-Film Thermoelectric Devices Based on p- and n-Type Poly(Metal 1,1,2,2-Ethenetetrathiolate)s/Polymer Composites through Ball-Milling. Philos. Trans. R. Soc. A Math. Phys. Eng. Sci. 2014, 372, 8. (c) Sun, Y.; Qiu, L.; Tang, L.; Geng, H.; Wang, H.; Zhang, F.; Huang, D.; Xu, W.; Yue, P.; Guan, Y.; et al. Flexible N-Type High-Performance Thermoelectric Thin Films of Poly(Nickel-Ethylenetetrathiolate) Prepared by an Electrochemical Method. Adv. Mater. 2016, 28 (17), 3351-3358. (d) Sun, L.; Liao, B.; Sheberla, D.; Kraemer, D.; Zhou, J.; Stach, E. A.; Zakharov, D.; Stavila, V.; Talin, A. A.; Ge, Y.; et al. A Microporous and Naturally Nanostructured Thermoelectric Metal-Organic Framework with Ultralow Thermal Conductivity. Joule 2017, 1 (1), 168-177.
(4) (a) Wang, Z. F.; Su, N.; Liu, F. Prediction of a Two-Dimensional Organic Topological Insulator. Nano Lett. 2013, 13(6), 2842-2845. (b) Kambe, T.; Sakamoto, R.; Kusamoto, T.; Pal, T.; Fukui, N.; Hoshiko, K.; Shimojima, T.; Wang, Z.; Hirahara, T.; Ishizaka, K.; et al. Redox Control and High Conductivity of Nickel Bis(Dithiolene) Complex π-Nanosheet: A Potential Organic Two-Dimensional Topological Insulator. J. Am. Chem. Soc. 2014, 136 (41), 14357-14360. (c) Chakravarty, C.; Mandal, B.; Sarkar, P. Bis(Dithiolene)-Based Metal-Organic Frameworks with Superior Electronic and Magnetic Properties: Spin Frustration to Spintronics and Gas Sensing. J. Phys. Chem. C, 2016, 120 (49), 28307-28319. (d) Liu, L.; DeGayner, J. A.; Sun, L.; Zee, D. Z.; Harris, T. D. Reversible Redox Switching of Magnetic Order and Electrical Conductivity in a 2D Manganese Benzoquinoid Framework. Chem. Sci. 2019, 10 (17), 4652-4661.
(5) (a) Clough, A. J.; Yoo, J. W.; Mecklenburg, M. H.; Marinescu, S. C. Two-Dimensional Metal-Organic Surfaces for Efficient Hydrogen Evolution from Water. J. Am. Chem. Soc. 2015, 137 (1), 118-121. (b) Dong, R.; Pfeffermann, M.; Liang, H.; Zheng, Z.; Zhu, X.; Zhang, J.; Feng, X. Large-Area, Free-Standing, Two-Dimensional Supramolecular Polymer Single-Layer Sheets for Highly Efficient Electrocatalytic Hydrogen Evolution. Angew. Chemie Int. Ed. 2015, 54 (41), 12058-12063. (c) Miner, E. M.; Fukushima, T.; Sheberla, D.; Sun, L.; Surendranath, Y.; Dinc\check{a}, M. Electrochemical Oxygen Reduction Catalysed by Ni₃(Hexaiminotriphenylene)₂. Nat. Commun. 2016, 7 (1), 10942. (d) Huang, X.; Yao, H.; Cui, Y.; Hao, W.; Zhu, J.; Xu, W.; Zhu, D. Conductive Copper Benzenehexathiol Coordination Polymer as a Hydrogen Evolution Catalyst. ACS Appl. Mater. Interfaces 2017, 9 (46), 40752-40759. (e) Miner, E. M.; Wang, L.; Dinc\check{a}, M. Modular O₂ Electroreduction Activity in Triphenylene-Based Metal-Organic Frameworks. Chem. Sci. 2018, 9 (29), 6286-6291. (f) Ji, Z.; Trickett, C.; Pei, X.; Yaghi, O. M. Linking Molybdenum-Sulfur Clusters for Electrocatalytic Hydrogen Evolution. J. Am. Chem. Soc. 2018, 140 (42), 13618-13622.
(6) (a) Tang, Q.; Zhou, Z. Electronic Properties of π-Conjugated Nickel Bis(Dithiolene) Network and Its Addition Reactivity with Ethylene. J. Phys. Chem. C, 2013, 117 (27), 14125-14129. (b) Campbell, M. G.; Sheberla, D.; Liu, S. F.; Swager, T. M.; Dinc\check{a}, M. Cu₃(Hexaiminotriphenylene)₂: An Electrically Conductive 2D Metal-Organic Framework for Chemiresistive Sensing. Angew. Chemie Int. Ed. 2015, 54 (14), 4349-4352. (c) Hendon, C. H.; Rieth, A. J.; Korzynski, M. D.; Dinc\check{a}, M. Grand Challenges and Future Opportunities for Metal-Organic Frameworks. ACS Cent Sci. 2017, pp 554-563. (d)Liu, L.; Li, L.; DeGayner, J. A.; Winegar, P. H.; Fang, Y.; Harris, T. D. Harnessing Structural Dynamics in a 2D Manganese-Benzoquinoid Framework To Dramatically Accelerate Metal Transport in Diffusion-Limited Metal Exchange Reactions. J. Am. Chem. Soc. 2018, 140 (36), 11444-11453. (e) Hoppe, B.; Hindricks, K. D. J.; Warwas, D. P.; Schulze, H. A.; Mohmeyer, A.; Pinkvos, T. J.; Zailskas, S.; Krey, M. R.; Belke, C.; König, S.; et al. Graphene-like Metal-Organic Frameworks: Morphology Control, Optimization of Thin Film Electrical Conductivity and Fast Sensing Applications. CrystEngComm 2018, 20 (41), 6458-6471.
(7) (a) Darago, L. E.; Aubrey, M. L.; Yu, C. J.; Gonzalez, M. I.; Long, J. R. Electronic Conductivity, Ferrimagnetic Ordering, and Reductive Insertion Mediated by Organic Mixed-Valence in a Ferric Semiquinoid Metal-Organic Framework. J. Am. Chem. Soc. 2015, 137 (50), 15703-15711. (b) Jeon, I.-R.; Negru, B.; Van Duyne, R. P.; Harris, T. D. A 2D Semiquinone Radical-Containing Microporous Magnet with Solvent-Induced Switching from Tc=26 to 80 K. J. Am. Chem. Soc. 2015, 137 (50), 15699-15702. (c) Jeon, I.-R.; Sun, L.; Negru, B.; Van Duyne, R. P.; Dinc\check{a}, M.; Harris, T. D. Solid-State Redox Switching of Magnetic Exchange and Electronic Conductivity in a Benzoquinoid-Bridged Mn II Chain Compound. J. Am. Chem. Soc. 2016, 138 (20), 6583-6590. (d) DeGayner, J. A.; Jeon, I.-R.; Sun, L.; Dinc\check{a}, M.; Harris, T. D. 2D Conductive Iron-Quinoid Magnets Ordering up to Tc=105 K via Heterogenous Redox Chemistry. J. Am. Chem. Soc. 2017, 139 (11), 4175-4184. (e) Ziebel, M. E.; Darago, L. E.; Long, J. R. Control of Electronic Structure and Conductivity in Two-Dimensional Metal-Semiquinoid Frameworks of Titanium, Vanadium, and Chromium. J. Am. Chem. Soc. 2018, 140 (8), 3040-3051. (f) DeGayner, J. A.; Wang, K.; Harris, T. D. A Ferric Semiquinoid Single-Chain Magnet via Thermally-Switchable Metal-Ligand Electron Transfer. J. Am. Chem. Soc. 2018, 140 (21), 6550-6553.
(8) (a) Sheberla, D.; Sun, L.; Blood-Forsythe, M. a; Er, S.; Wade, C. R.; Brozek, C. K.; Aspuru-Guzik, A.; Dinc\check{a}, M. High Electrical Conductivity in Ni₃(2,3,6,7,10,11-Hexaiminotriphenylene)₂, a Semiconducting Metal-Organic Graphene Analogue. J. Am. Chem. Soc. 2014, 136 (25), 8859-8862. (b) Dou, J. H.; Sun, L.; Ge, Y.; Li, W.; Hendon, C. H.; Li, J.; Gul, S.; Yano, J.; Stach, E. A.; Dinc\check{a}, M. Signature of Metallic Behavior in the Metal-Organic Frameworks M₃(Hexaiminobenzene)₂ (M=Ni, Cu). J. Am. Chem. Soc. 2017, 139 (39), 13608-13611.
(9) (a) Kambe, T.; Sakamoto, R.; Hoshiko, K.; Takada, K.; Miyachi, M.; Ryu, J. H.; Sasaki, S.; Kim, J.; Nakazato, K.; Takata, M.; et al. r-Conjugated Nickel Bis(Dithiolene) Complex Nanosheet. J. Am. Chem. Soc. 2013, 135 (7), 2462-2465. (b) Huang, X.; Sheng, P.; Tu, Z.; Zhang, F.; Wang, J.; Geng, H.; Zou, Y.; Di, C.; Yi, Y.; Sun, Y.; et al. A Two-Dimensional π-d Conjugated Coordination Polymer with Extremely High Electrical Conductivity and Ambipolar Transport Behaviour. Nat. Commun. 2015, 6 (1), 7408. (c) Maeda, H.; Sakamoto, R.; Nishihara, H. Coordination Programming of Two-Dimensional Metal Complex Frameworks. Langmuir 2016, 32 (11), 2527-2538. (d) Huang, X.; Li, H.; Tu, Z.; Liu, L.; Wu, X.; Chen, J.; Liang, Y.; Zou, Y.; Yi, Y.; Sun, J.; et al. Highly Conducting Neutral Coordination Polymer with Infinite Two-Dimensional Silver-Sulfur Networks. J. Am. Chem. Soc. 2018, 140 (45), 15153-15156. (e) Dong, R.; Han, P.; Arora, H.; Ballabio, M.; Karakus, M.; Zhang, Z.; Shekhar, C.; Adler, P.; Petkov, P. S.; Erbe, A.; et al. High-Mobility Band-like Charge Transport in a Semiconducting Two-Dimensional Metal-Organic Framework. Nat. Mater. 2018, 17 (11), 1027-1032. (f) Cui, Y.; Yan, J.; Chen, Z.; Zhang, J.; Zou, Y.; Sun, Y.; Xu, W.; Zhu, D. [Cu₃(C₆Se₆)]N: The First Highly Conductive 2D π-d Conjugated Coordination Polymer Based on Benzenehexaselenolate. Adv. Sci. 2019, 6 (9), 1802235.
(10) (a) Sun, L.; Miyakai, T.; Seki, S.; Dinc\check{a}, M. Mn2(2,5-Disulfhydrylbenzene-1,4-Dicarboxylate): A Microporous Metal-Organic Framework with Infinite (—Mn—S—)∞ Chains and High Intrinsic Charge Mobility. J. Am. Chem. Soc. 2013, 135 (22), 8185-8188. (b) Sun, L.; Campbell, M. G.; Dinc\check{a}, M. Electrically Conductive Porous Metal-Organic Frameworks. Angew. Chemie Int. Ed. 2016, 55 (11), 3566-3579. (c) Horwitz, N. E.; Xie, J.; Filatov, A. S.; Papoular, R. J.; Shepard, W. E.; Zee, D. Z.; Grahn, M. P.; Gilder, C.; Anderson, J. S. Redox-Active 1 D Coordination Polymers of Iron-Sulfur Clusters. J. Am. Chem. Soc. 2019, 141 (9), 3940-3951.
(11) (a) Segura, J. L.; Martn, N. New Concepts in Tetrathiafulvalene Chemistry. Angew. Chemie Int. Ed. 2001, 1372-1409. (b) Wang, H.; Cui, L.; Xie, J.; Leong, C. F.; D'Alessandro, D. M.; Zuo, J. Functional Coordination Polymers Based on Redox-Active Tetrathiafulvalene and Its Derivatives. Coord. Chem. Rev. 2017, 345, 342-361.
(12) Bryce, M. R. Recent Progress on Conducting Organic Charge-Transfer Salts. Chem. Soc. Rev. 1991, 20 (3), 355.
(13) (a) Narayan, T. C.; Miyakai, T.; Seki, S.; Dinc\check{a}, M. High Charge Mobility in a Tetrathiafulvalene-Based Microporous Metal-Organic Framework. J. Am. Chem. Soc. 2012, 134 (31), 12932-12935. (b) Sun, L.; Park, S. S.; Sheberla, D.; Dinc\check{a}, M. Measuring and Reporting Electrical Conductivity in Metal-Organic Frameworks: Cd2(TTFTB) as a Case Study. J. Am. Chem. Soc. 2016, 138 (44), 14772-14782. (c) Xie, L. S.; Dinc\check{a}, M. Novel Topology in Semiconducting Tetrathiafulvalene Lanthanide Metal-Organic Frameworks. Isr. J. Chem. 2018, 58 (9-10), 1119-1122. (d) Xie, L. S.; Alexandrov, E. V.; Skorupskii, G.; Proserpio, D. M.; Dinc\check{a}, M. “Diverse Π-Π Stacking Motifs Modulate Electrical Conductivity in Tetrathiafulvalene-Based Metal-Organic Frameworks” Chem. Sci. 2019.
(14) (a) McCullough, R. D.; Belot, J. A. Toward New Magnetic, Electronic, and Optical Materials: Synthesis and Characterization of New Bimetallic Tetrathiafulvalene Tetrathiolate Building Blocks. Chem. Mater. 1994, 6 (8), 1396-1403. (b) McCullough, R. D.; Belot, J. A.; Seth, J.; Rheingold, A. L.; Yap, G. P. A.; Cowan, D. O. Building Block Ligands for New Molecular Conductors: Homobimetallic Tetrathiafulvalene Tetrathiolates and Metal Diselenolenes and Ditellurolenes. J. Mater. Chem. 1995, 5 (10), 1581.
(15) (a) Matsuo, Y.; Maruyama, M.; Gayathri, S. S.; Uchida, T.; Guldi, D. M.; Kishida, H.; Nakamura, A.; Nakamura, E. “π-ConjugatedMultidonor/Acceptor Arrays of Fullerene-Cobaltadithiolene-Tetrathiafulvalene: From Synthesis and Structure to Electronic Interactions” J. Am. Chem. Soc. 2009, 131, 12643-12649. (b) Bellec, N.; Vacher, A.; Barriére, F.; Xu, Z.; Roisnel, T.; Lorcy, D. Interplay between Organic-Organometallic Electrophores within Bis(Cyclopentadienyl)Molybdenum Dithiolene Tetrathafulvalene Complexes. Inorg. Chem. 2015, 54 (10), 5013-5020.
(16) Svenstrup, N.; Rasmussen, K. M.; Hansen, T. K.; Becher, J. The Chemistry of TTFTT; 1: New Efficient Synthesis and Reactions of Tetrathiafulvalene-2,3,6,7-Tetrathiolate (TTFTT): An Important Building Block in TTF-Syntheses. Synthesis. 1994, 809-812.
(17) (a) Ashton, P. R.; Balzani, V.; Becher, J.; Credi, A.; Fyfe, M. C. T.; Mattersteig, G.; Menzer, S.; Nielsen, M. B.; Raymo, F. M.; Stoddart, J. F.; et al. A Three-Pole Supramolecular Switch. J. Am. Chem. Soc. 1999, 121 (16), 3951-3957. (b) Wang, L.; Zhang, J.-P.; Zhang, B. Bis[Tetrakis-(Methylsulfanyl)Tetrathiafulvalenium] Oxalate Dichloride. Acta Crystallogr. Sect. E Struct. Reports Online 2005, 61 (6), 1674-1676. (c) Beck, J.; Bof de Oliveira, A. On the Oxidation of Octamethylenetetrathiafulvalene by CuBr2-Synthesis, Crystal Structure and Magnetic Properties of (OMTTF)₂ Cu₄Br₁₀]. Zeitschrift für Anorg. und Allg. Chemie 2009, 635 (3), 445-449. (d) Wang, Y.; Cui, S.; Li, B.; Zhang, J.; Zhang, Y. Synthesis and Characterization of Monosubstituted TTF and Its Solvent Dependent Mono- and Dication Charge-Transfer Salts. Cryst. Growth Des. 2009, 9 (9), 3855-3858. (e) Barin, G.; Frasconi, M.; Dyar, S. M.; lehl, J.; Buyukcakir, O.; Sarjeant, A. A.; Carmieli, R.; Coskun, A.; Wasielewski, M. R.; Stoddart, J. F. Redox-Controlled Selective Docking in a [2]Catenane Host. J. Am. Chem. Soc. 2013, 135 (7), 2466-2469. (f) Gao, F.; Zhu, F.; Wang, X.-Y.; Xu, Y.; Wang, X.; Zuo, J. Stabilizing Radical Cation and Dication of a Tetrathiafulvalene Derivative by a Weakly Coordinating Anion. Inorg. Chem. 2014, 53 (10), 5321-5327.

(18) (a) Mori, T.; Inokuchi, H. Crystal and Electronic Structures of (BEDT-TTF)AuCl₂AuCl₄. Chem. Lett. 1986, 15 (12), 2069-2072. (b) Shibaeva, R. P.; Lobkovskaya, R. M.; Korotkov, V. E.; Kusch, N. D.; Yagubskii, É. B.; Makova, M. K. ET Cation-Radical Salts with Metal Complex Anions. Synth. Met. 1988, 27(1-2), 457-463. (c) Abboud, K. A.; Clevenger, M. B.; De Oliveira, G. F.; Talham, D. R. Dication Salt of Bis(Ethylenedithio)Tetrathiafulvalene: Preparation and Crystal Structure of BEDT-TTF(ClO₄)₂. J. Chem. Soc. Chem. Commun. 1993, 20, 1560-1562. (d) Mori, T.; Inokuchi, H. A BEDT-TTF Complex Including a Magnetic Anion, (BEDT-TTF)₃(MnCl₄)₂. Bull. Chem. Soc. Jpn. 1988, 61 (2), 591-593. (e) Clemente-León, M. Hybrid Molecular Materials Based upon Organic r-Electron Donors and Inorganic Metal Complexes. Conducting Salts of Bis(Ethylenediseleno)Tetrathiafulvalene (BEST) with the Octahedral Anions Hexacyanoferrate(III) and Nitroprusside. J. Solid State Chem. 2002, 168 (2), 616-625. (f) Xiao, X.; Xu, H.; Xu, W.; Zhang, D.; Zhu, D. Two Dication Salts of ET: Preparation and Crystal Structures of ET [Fe^{II}(CN)₄(CO)₂]. Synth. Met. 2004, 144 (1), 51-53. (g) Belo, D.; Rodrigues, C.; Santos, I. C.; Silva, S.; Eusébio, T.; Lopes, E. B.; Rodrigues, J. V.; Matos, M. J.; Almeida, M.; Duarte, M. T.; et al. Synthesis, Crystal Structure and Magnetic Properties of Bis(3,4;3′,4′-Ethylenedithio)2,2′,5,5′-Tetrathiafulvalene-Bis(Cyanoimidodithiocarbonate)Aurate(III), (BEDT-TTf)[Au(CDC-)2]. Polyhedron 2006, 25 (5), 1209-1214. (h) Minemawari, H.; Naito, T.; Inabe, T. (ET)3(Br3)5: A Metallic Conductor with an Unusually High Oxidation State of ET (ET=Bis(Ethylenedithio)Tetrathiafulvalene). Chem. Lett. 2007, 36 (1), 74-75. (i) Minemawari, H.; Jose, J. F. F.; Takahashi, Y.; Naito, T.; Inabe, T. Structural Characteristics in a Stable Metallic ET Salt with Unusually High Oxidation State (ET: Bis(Ethylenedithio)Tetrathiafulvalene). Bull. Chem. Soc. Jpn. 2012, 85 (3), 335-340. (o) Zecchini, M.; Lopez, J. R.; Allen, S. W.; Coles, S. J.; Wilson, C.; Akutsu, H.; Martin, L.; Wallis, J. D. Exo-Methylene-BEDT-TTF and Alkene-Functionalised BEDT-TTF Derivatives: Synthesis and Radical Cation Salts. RSC Adv. 2015, 5 (39), 31104-31112.

(19) Wu, J.-C.; Liu, S.-X.; Keene, T. D.; Neels, A.; Mereacre, V.; Powell, A. K.; Decurtins, S. Coordination Chemistry of a r-Extended, Rigid and Redox-Active Tetrathiafulvalene-Fused Schiff-Base Ligand. Inorg. Chem. 2008, 47 (8), 3452-3459.
(20) (a) Spanggaard, H.; Prehn, J.; Nielsen, M. B.; Levillain, E.; Allain, M.; Becher, J. Multiple-Bridged Bis-Tetrathiafulvalenes: New Synthetic Protocols and Spectroelectrochemical Investigations. J. Am. Chem. Soc. 2000, 122 (39), 9486-9494. (b) Massue, J.; Bellec, N.; Chopin, S.; Levillain, E.; Roisnel, T.; Clérac, R.; Lorcy, D. Electroactive Ligands: The First Metal Complexes of Tetrathiafulvenyl-Acetylacetonate. Inorg. Chem. 2005, 44 (24), 8740-8748. (c) Nielsen, M. B.; Lomholt, C.; Becher, J. Tetrathiafulvalenes as Building Blocks in Supramolecular Chemistry II. Chem. Soc. Rev. 2000, 29 (3), 153-164.
(21) Di Valentin, M.; Bisol, A.; Agostini, G.; Liddell, P. A.; Kodis, G.; Moore, A. L.; Moore, T. A.; Gust, D.; Carbonera, D. Photoinduced Long-Lived Charge Separation in a Tetrathiafulvalene-Porphyrin-Fullerene Triad Detected by Time-Resolved Electron Paramagnetic Resonance. J. Phys. Chem. B 2005, 109 (30), 14401-14409.
(22) Khodorkovsky, V.; Shapiro, L.; Krief, P.; Shames, A.; Mabon, G.; Gorgues, A.; Giffard, M. Do π-Dimers of Tetrathiafulvalene Cation Radicals Really Exist at Room Temperature? Chem. Commun. 2001, 1 (24), 2736-2737.
(23) (a) Tanaka, H. A Three-Dimensional Synthetic Metallic Crystal Composed of Single-Component Molecules. Science 2001, 291, 285-287. (b) Matsubayashi, G.; Nakano, M.; Tamura, H. Structures and Properties of Assembled Oxidized Metal Complexes with C₈H₄S₈ and Related Sulfur-Rich Dithiolate Ligands. Coord. Chem. Rev. 2002, 226 (1-2), 143-151. (c) Kobayashi, A.; Fujiwara, E.; Kobayashi, H. Single-Component Molecular Metals with Extended-TTF Dithiolate Ligands. Chem. Rev. 2004, 104 (11), 5243-5264. (d) Okano, Y.; Zhou, B.; Tanaka, H.; Adachi, T. High-Pressure (up to 10.7 GPa) Crystal Structure of Single-Component Molecular Metal [Au (TMDT) 2]. 2009, No. 6, 7169-7174. (e) Zhou, B.; Idobata, Y.; Kobayashi, A.; Cui, H.; Kato, R.; Takagi, R.; Miyagawa, K.; Kanoda, K.; Kobayashi, H. Single-Component Molecular Conductor [Cu(DMDT)₂] with Three-Dimensionally Arranged Magnetic Moments Exhibiting a Coupled Electric and Magnetic Transition. J. Am. Chem. Soc. 2012, 134 (30), 12724-12731. (f) Cui, H.; Kobayashi, H.; Ishibashi, S., Sasa, M.; Iwase, F.; Kato, R.; Kobayashi, A. A Single-Component Molecular Superconductor. J. Am. Chem. Soc. 2014, 136 (21), 7619-7622. (g) Zhou, B.; Ogura, S.; Liu, Q. Z.; Kasai, H.; Nishibori, E.; Kobayashi, A. A Single-Component Molecular Conductor with Metal-MetalBonding, [Pd(Hfdt)2] (Hfdt: Bis(Trifluoromethyl)Tetrathiafulvalene-dithiolate). Chem. Lett. 2016, 45 (3), 303-305. (h) Valade, L.; de Caro, D.; Faulmann, C.; Jacob, K. TTF[Ni(Dmit)₂]₂: From Single-Crystals to Thin Layers, Nanowires, and Nanoparticles. Coord. Chem. Rev. 2016, 308, 433-444. (i) Silva, R.; Vieira, B.; Andrade, M.; Santos, I.; Rabaça, S.; Lopes, E.; Coutinho, J.; Pereira, L.; Almeida, M.; Belo, D. Gold and Nickel Extended Thiophenic-TTF Bisdithiolene Complexes. Molecules 2018, 23 (2), 424. (j) Zhou, B.; Ishibashi, S.; Ishii, T.; Sekine, T.; Takehara, R.; Miyagawa, K.; Kanoda, K.; Nishibori, E.; Kobayashi, A. Single-Component Molecular Conductor [Pt(Dmdt)₂]—a Three-Dimensional Ambient-Pressure Molecular Dirac Electron System. Chem. Commun. 2019, 55 (23), 3327-3330.
(24) Lu, W.; Zhang, Y.; Dai, J.; Zhu, Q.-Y.; Bian, G.-Q.; Zhang, D.-Q. A Radical-Radical and Metal-Metal Coupling Tetrathiafulvalene Derivative in Which Organic Radicals Directly Coordinate to Cu^{II} Ions. Eur. J. Inorg. Chem. 2006, 2006 (8), 1629-1634.
(25) (a) Nakata, M.; Nakatsuji, H.; Ehara, M.; Fukuda, M.; Nakata, K.; Fujisawa, K. Variational Calculations of Fermion Second-Order Reduced Density Matrices by Semidefinite Programming Algorithm. J. Chem. Phys. 2001, 114, 8282-8292. (b) Mazziotti, D. A. Realization of Quantum Chemistry without Wave Functions through First-Order Semidefinite Programming. Phys. Rev. Lett. 2004, 93, 213001. (c) Mazziotti, D. A., Ed. Variational Two-Electron Reduced-Density Matrix Theory. In Reduced-Density-Matrix Mechanics: With Application to Many-Electron Atoms and Molecules; John Wiley and Sons, Inc.: Hoboken, N.J., 2007; pp 19-59. (d) Gidofalvi, G. and Mazziotti, D. A. Active-Space Two-Electron Reduced-Density-Matrix Method: Complete Active-Space Calculations without Diagonalization of the N-electron Hamiltonian. J. Chem. Phys. 2008, 129, 134108. (e) Shenvi, N.; Izmaylov, A. F. Active-Space N-Representability Constraints for Variational Two-Particle Reduced Density Matrix Calculations. Phys. Rev. Lett. 2010, 105, 213003. (f) Mazziotti, D. A. Large-Scale Semidefinite Programming for Many-Electron Quantum Mechanics Phys. Rev. Lett. 2011, 106, 083001. (g) Mazziotti, D. A. Two-Electron Reduced Density Matrix as the Basic Variable in Many-Electron Quantum Chemistry and Physics. Chem. Rev. 2012, 112, 244. (h) Verstichel, B.; van Aggelen, H.; Poelmans, W.; Van Neck, D. Variational Two-Particle Density Matrix Calculation for the Hubbard Model Below Half Filling Using Spin-Adapted Lifting Conditions. Phys. Rev. Lett. 2012, 108, 213001. (i) Fosso-Tande, J.; Nguyen, T.-S.; Gidofalvi, G.; DePrince, A. E., III Large-Scale Variational Two-Electron Reduced-Density-Matrix Driven Complete Active Space Self-Consistent Field Methods. J. Chem. Theory Comput. 2016, 12, 2260-2271. (j) Mazziotti, D. A. Enhanced Constraints for Accurate Lower Bounds on Many-Electron Quantum Energies from Variational Two Electron Reduced Density Matrix Theory. Phys. Rev. Lett. 2016, 117, 153001.
(26) (a) Schlimgen, A. W.; Heaps, C. W.; Mazziotti, D. A. Entangled Electrons Foil Synthesis of Elusive Low-Valent Vanadium Oxo Complex. J. Phys. Chem. Lett 2016, 7, 627-631. (b) Schlimgen, A. W.; Mazziotti, D. A. Static and Dynamic Electron Correlation in the Ligand Noninnocent Oxidation of Nickel Dithiolates. J. Phys. Chem. A 2017, 121, 9377-9384. (c) Mclsaac, A. R.; Mazziotti, D. A. Ligand Non-innocence and Strong Correlation in Manganese Superoxide Dismutase Mimics. Phys. Chem. Chem. Phys. 2017, 19, 4656-4660. (d) Montgomery, J. M.; Mazziotti, D. A. Strong Electron Correlation in Nitrogenase Cofactor, FeMoco. J. Phys. Chem. A 2018, 122, 4988-4996.
(27) Maple Quantum Chemistry Toolbox (2019). Maplesoft, a division of Waterloo Maple Inc., Waterloo, Ontario.
(28) (a) Binkley, J.; Pople, J.; Hehre, W. Self-consistent Molecular Orbital Methods. 21. Small Split-valence Basis Sets for First-row Elements. J. Am. Chem. Soc. 1980, 102, 939-947. (b) Gordon, M.; Binkley, J.; Pople, J.; Pietro, W.; Hehre, W. Self consistent Molecular Orbital Methods. 22. Small Split-valence Basis Sets for Second-row Elements. J. Am. Chem. Soc. 1982, 104, 2797-2803. (c) Dobbs, K.; Hehre, W. Molecular Orbital Theory of the Properties of Inorganic and Organometallic Compounds. 5. Extended Basis Sets for First-row Transition Metals. J. Comput. Chem. 1987, 8, 861-879. (d) Dobbs, K.; Hehre, W. Molecular Orbital Theory of the Properties of Inorganic and Organometallic Compounds. 6. Extended Basis Sets for Second-row Transition Metals. J. Comput. Chem. 1987, 8, 880-893.
(29) Alvarez, S.; Vicente, R.; Hoffmann, R. Dimerization and Stacking in Transition-Metal Bisdithiolenes and Tetrathiolates. J. Am. Chem. Soc. 1985, 107 (22), 6253-6277.
(30) Vogt, T.; Faulmann, C.; Soules, R.; Lecante, P.; Mosset, A.; Castan, P.; Cassoux, P.; Galy, J. A LAXS (Large Angle X-Ray Scattering) and EXAFS (Extended X-Ray Absorption Fine Structure) Investigation of Conductive Amorphous Nickel Tetrathiolato Polymers. J. Am. Chem. Soc. 1988, 110 (6), 1833-1840.
(31) (a) Van Hecke, G. R.; Horrocks, W. D. Ditertiary Phosphine Complexes of Nickel. SpeCtral, Magnetic, and Proton Resonance Studies. A Planar-Tetrahedral Equilibrium. Inorg. Chem. 1966, 5 (11), 1968-1974. (b) Angulo, I. M.; Bouwman, E.; van Gorkum, R.; Lok, S. M.; Lutz, M.; Spek, A. L. New Nickel-Containing Homogeneous Hydrogenation Catalysts. J. Mol. Catal. A Chem. 2003, 202 (1-2), 97-106.
(32) Chevez, I.; Alvarez-Carena, A.; Molins*, E.; Roig, A.; Maniukiewicz, W.; Arancibia, A.; Arancibia, V.; Brand, H.; Manuel Manriquez, J. Selective Oxidants for Organometallic Compounds Containing a Stabilising Anion of Highly Reactive Cations: (3,5(CF₃)₂C₆H₃)₄B⁻)Cp₂Fe⁺ and (3,5(CF₃)₂C₆H₃)₄B⁻)Cp*2Fe⁺. J. Organomet. Chem. 2000, 601 (1), 126-132.

It will be understood that various details of the presently disclosed subject matter may be changed without departing from the scope of the presently disclosed subject matter. Furthermore, the foregoing description is for the purpose of illustration only, and not for the purpose of limitation.

1. A coordination complex having a structure of Formula (I): 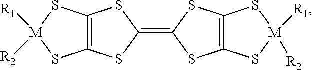
wherein:
M is selected from Si, Ge, and Sn; and
R₁ and R₂ are independently selected from alkyl, aralkyl, and aryl.

2. The coordination complex of claim 1, wherein M is Sn.

3. The coordination complex of claim 1, wherein M is Si.

4. The coordination complex of claim 1, wherein R₁ and R₂ are each C₁-C₆ alkyl.

5. The coordination complex of claim 4, wherein R₁ and R₂ are each butyl.

6. The coordination complex of claim 1, wherein R₁ and R₂ are each phenyl.

7. A complex comprising (a) an oxidation product of the coordination complex of claim 1, wherein said oxidation product comprises a cation radical or a dication, and (b) an anionic species.

8. A method of preparing a coordination polymer, wherein the method comprises:
(a) providing a first coordination complex having a structure of Formula (I): 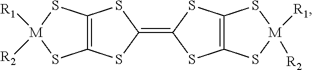
wherein:
M is a first metal selected from Si, Ge, and Sn; and
R₁ and R₂ are independently selected from alkyl, aralkyl, and aryl; and
(b) contacting the first coordination complex from (a) with a second coordination complex comprising a second metal M′, wherein M′ is a transition metal, thereby forming a coordination polymer comprising repeating coordination complexes comprising M′ and tetrathiolate ligands.

9. The method of claim 8, wherein M′ is selected from Fe, Cr, Mo, Ni, W, Co, Cu, and Mn.

10. The method of claim 8, wherein the second coordination complex comprises a metal cluster comprising the second metal M′.

11. The method of claim 10, wherein the metal cluster is a metal sulfur cluster.

12. The method of claim 8, further comprising contacting the first coordination complex with an oxidant prior to or during step (b).

13. The method of claim 12, wherein the method provides a coordination polymer with improved conductivity compared to a coordination polymer formed by contacting the first coordination complex with the second coordination complex without contacting the first coordination complex with one or more oxidant prior to or during the contacting with the second coordination complex.

14. The method of claim 13, wherein the conductivity is improved by about 1000 times.

15. The method of claim 12, wherein the first coordination complex is contacted with at least one equivalent of the oxidant.

16. The method of claim 12, wherein the oxidant is a ferrocenium compound.

17. The method of claim 16, wherein the ferrocenium compound is an acetyl ferrocenium.

18. The method of claim 16, wherein the ferrocenium compound is a benzoyl ferrocenium compound.

19. The method of claim 16, wherein the ferrocenium compound is a salt of a borate anion.

20. The method of claim 19, wherein the borate anion is tetrakis(3,5-bis(trifluoromethyl)phenyl) borate.

21. The method of claim 8, further comprising adding a modulating agent during step (b).

22. The method of claim 21, wherein the modulating agent is thiophenol.

23. The coordination polymer prepared according to the method of claim 8.

24. A method of preparing a coordination polymer, wherein the method comprises:
(a) providing a mixture comprising at least two first coordination complexes, wherein each of said two first coordination complexes is selected from the group consisting of:
(i) a coordination complex having a structure of Formula (I): 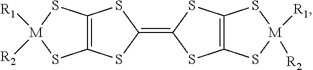
wherein:
M is a first metal selected from Si, Ge, and Sn; and R₁ and R₂ are independently selected from alkyl, aralkyl, and aryl;
(ii) a cation radical thereof; and
(iii) a dication thereof; and
(b) contacting the mixture from (a) with a second coordination complex comprising a second metal M′, wherein M′ is a transition metal, thereby forming a coordination polymer comprising repeating coordination complexes comprising M′ and tetrathiolate ligands.

25. The method of claim 24, wherein M′ is selected from Fe, Cr, Mo, Ni, W, Co, Cu, and Mn.

26. The method of claim 24, wherein the second coordination complex comprises a metal cluster comprising the second metal M′.

27. The method of claim 26, wherein the metal cluster is a metal sulfur cluster.

28. The method of claim 24, wherein the method provides a coordination polymer with improved conductivity compared to a coordination polymer formed by contacting the second metal complex with a first coordination complex having a structure of Formula (I) without a second first coordination complex.

29. The method of claim 24, wherein the ratio of first coordination complexes is selected to provide a coordination complex with a particular level of cation radical and/or dication doping.

30. The method of claim 24, further comprising adding a modulating agent during step (b).

31. The method of claim 30, wherein the modulating agent is thiophenol.

32. The coordination polymer prepared according to the method of claim 24.

33. A coordination polymer comprising repeating coordination complexes comprising (i) a transition metal or a transition metal cluster and (ii) tetrathiolate ligands, wherein the tetrathiolate ligands comprise tetrathiafulvalene-2,3,6,7-tetrathiolate (TTFtt) and/or an oxidation product thereof, wherein said repeating coordination complexes extend in one, two or three dimensions.

34. The coordination polymer of claim 33, wherein the transition metal is selected from Fe, Cr, Mo, Ni, W, Co, Cu and Mn.

35. The coordination polymer of claim 33, wherein the transition metal is part of a transition metal cluster.

36. The coordination polymer of claim 35, wherein the transition metal cluster is a metal sulfur cluster.

37. The coordination polymer of claim 33, wherein the coordination polymer has a conductivity that is greater than about 0.0001 S/cm.

38. A method of doping a coordination polymer, the method comprising:
(a) providing a mixture of at least two different types of ligands selected from the group consisting of tetrathiafulvalene-2,3,6,7-tetrathiolate (TTFtt), a cation radical thereof, and a dication thereof; and
(b) contacting the mixture of ligands with a transition metal M′.

39. The method of claim 38, wherein the mixture of ligands comprises a predetermined ratio of the at least two different types of ligands, wherein the ratio is predetermined to achieve a desired doping level of oxidation states in the coordination polymer.

40. The method of claim 38, wherein at least one of the at least two different types of ligands is provided as a tin, silicon, or germanium coordination complex.

41. The method of claim 38, wherein the transition metal M′ is part of a coordination complex or a metal cluster.

42. A composition comprising a mixture of at least two types of tetrathiafulvalene-2,3,6,7-tetrathiolate (TTFtt) ligands wherein each type of ligand has a different oxidation state.

43. The composition of claim 42, wherein the mixture comprises at least two of:
(i) a coordination complex having a structure of Formula (I): 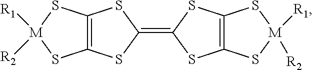
wherein:
M is a first metal selected from Si, Ge, and Sn; and R₁ and R₂ are independently selected from alkyl, aralkyl, and aryl;
(ii) a cation radical thereof; and
(iii) a dication thereof.
